(19) United States
(12) Patent Application Publication
(10) Pub. No.: US 2024/0166569 A1
(43) Pub. Date: May 23, 2024

(54) TEMPLATED MATERIALS, METHODS OF MAKING SAME, AND USES THEREOF

(71) Applicant: Cornell University, Ithaca, NY (US)

(72) Inventors: Ulrich B. Wiesner, Ithaca, NY (US); R. Paxton Thedford, Ithaca, NY (US); Peter A. Beaucage, Gaithersburg, MD (US); Ethan M. Susca, Portland, OR (US); Sol M. Gruner, Ithaca, NY (US)

(21) Appl. No.: 18/548,813

(22) PCT Filed: Mar. 1, 2022
(86) PCT No.: PCT/US2022/018363

§ 371 Date: Sep. 1, 2023

Related U.S. Application Data
(60) Provisional application No. 63/155,153, filed on Mar. 1, 2021.

(51) Int. Cl. C04B 41/51; C04B 35/56; C04B 41/00; C04B 41/45

(52) U.S. Cl. CPC C04B 41/515; C04B 35/5603; C04B 41/0072; C04B 41/4523; C04B 2235/3873; C04B 2235/3895

(57) ABSTRACT

Methods of making templated materials using BCP-derived templates, nanocomposites and compositions. The methods use pressure to fill a BCP-derived template with an inorganic material or materials and/or organic material or organic materials to form a templated material. A nanocomposite, which may be a templated material, may include an inorganic material or materials and/N or organic material or materials defining a three-dimensional space and a BCP-derived material disposed on at least a portion of the inorganic material(s) and/or organic material(s). A composition, which may be a templated material where the BCP-derived template is removed, may include an inorganic material or materials and/or organic material or materials defining a three-dimensional space. A device may include nanocomposite(s) and/or composition(s). A device may be an electronic device, energy device, a sensor, or the like.

### CROSS-REFERENCE TO RELATED APPLICATIONS

This application claims the benefit of U.S. Provisional Patent Application No. 63/155,153, filed Mar. 1, 2021, the contents of the above-identified application are hereby fully incorporated herein by reference in their entirety.

### STATEMENT REGARDING FEDERALLY SPONSORED RESEARCH AND DEVELOPMENT

This invention was made with government support under grant nos. SC0010560 and SC0017631 awarded by the Department of Energy and 1650441 awarded by the National Science Foundation. The government has certain rights in the invention.

### BACKGROUND OF THE DISCLOSURE

Synthesis of quantum materials is currently focused at the atomic scale, but many interesting phenomena could lurk in structures defined by their order on the scale of tens to hundreds of nanometers. It is known that mesoscale features can impart desirable attributes in superconductors for instance, such as improvement in critical temperature or current. Extensive work has been performed on the effect of two dimensional confinement or ordering in the thin film regime, demonstrating for example the thickness dependence of transition temperature and tunable flux pinning in thin film periodic arrays. In contrast, there have been far fewer investigations of three dimensionally (3D) ordered superconductors, and of the existing studies in this vein all but a handful focus on isolated nano-objects or nano-wires.

The experimental realization of these metamaterials has been limited, however, by a lack of accessible synthesis routes for high-quality metallic materials from bulk BCP self-assembled structures. High fidelity transfer of self-assembled architectures into metals has been considered a grand challenge in BCP structure directed materials for the past decade. While strides have been made towards mesostructured metals via the incorporation of metallic nanoparticles in a specific BCP domain, most approaches focus on backfilling a BCP self-assembly directed porous structure with metal by electro- or electroless deposition. Such methods typically only achieve complete and uniform backfilling in thin films through careful control of synthetic parameters, and lack generalizability.

### SUMMARY OF THE DISCLOSURE

In various examples, a method of making a templated material comprises contacting one or more inorganic material(s) and/or one or more organic material(s), or a combination thereof with a mesoporous block copolymer (BCP)-derived template defining a three-dimensional space, applying a pressure to the inorganic material(s) and/or the organic material(s), or the combination thereof. The inorganic material(s) and/or the organic material(s), or the combination thereof at least partially, substantially, or completely fills the three-dimensional space forming a templated material. In various examples, the contacting and applying are carried out at the same time, substantially the same time, or at different times.

In various examples, the inorganic material(s) are chosen from ceramic materials, amorphous glasses, semiconductor materials, metal(s), metal alloy(s), non-metal inorganic materials, and any combination thereof and/or the organic material(s) are chosen from polymers, oligomers, and organic molecules having a molar mass of 500 g/mol or less, and any combination thereof. In various examples, the inorganic material(s) and/or the organic material(s), or the combination thereof is a liquid or the inorganic material(s) and/or the organic material(s), and/or the combination thereof is a solid at a temperature about or at or above one half of the melting point or glass transition of the inorganic material(s) and/or the organic material(s). In various examples, the inorganic material(s) and/or the organic material(s), or the combination thereof is in the form of a melt.

In various examples, the BCP template is monolithic, a free-standing film, or a film disposed on at least a portion of or all of a surface or all of the surfaces of a substrate. In various examples, the BCP-derived template comprises a ceramic material or a carbonaceous material. In various examples, the BCP-derived template is a quantum confined material or exhibits one or more superconducting behavior(s). In various examples, the BCP-derived templated material and/or templated material exhibits atomic level order and/or mesoscale level order or the BCP-derived templated material and/or templated material exhibits atomic level disorder and/or mesoscale level disorder. In various examples, templated material has the same mesoscale order as the BCP-derived template material. In various examples, the BCP-derived template comprises one or more interpenetrating network(s) and at least a portion of or all of the void space network(s) are filled with templated material(s). In various examples, the BCP-derived is continuous or co-continuous.

In various examples, the pressure is provided by an inert gas, an inert fluid, or an inert liquid or is a mechanical pressure. In various examples, the pressure is greater than about 1 atm to 10⁴ atm.

In various examples, the method further comprising removing at least a portion of, substantially all, or all of the BCP-derived template. In various examples, the method further comprising annealing the BCP-derived template and templated material or the templated material before or after removal of at least a portion of, substantially all, or all of the BCP-derived template.

In various examples, a nanocomposite material comprises one or more inorganic material(s), one or more organic material(s), or any combination thereof defining a three-dimensional space and a BCP-derived material. The BCP-derived material is disposed on at least at a portion of or substantially all of a surface or surfaces of the inorganic material(s), the organic material(s), or the combination thereof. In various examples, the nanocomposite is monolithic, a free-stranding film, or a film disposed on at least a portion of or all of a surface or all of the surfaces of a substrate. In various examples, the one or more inorganic material(s), one or more organic material(s), or any combination thereof has/have the same mesoscale order as the BCP-derived template material.

In various examples, the inorganic material(s), the organic material(s), or the combination thereof or at least a portion thereof is continuous or co-continuous and comprises at least one surface access point. In various examples, the inorganic material(s), the organic material(s), or the combination thereof are symmetric or ordered inorganic material(s), symmetric or ordered organic material(s), or any combination thereof or asymmetric or disordered inorganic material(s), asymmetric or disordered organic material(s), or any combination thereof. In various examples, the inorganic material(s) are chosen from ceramic materials, amorphous glasses, semiconductor materials, metals, metal alloys, non-metal inorganic materials, and any combination thereof and/or the organic material(s) are chosen from polymers, oligomers, organic molecules having a molar mass of 500 g/mol or less, and any combination thereof. In various examples, the metal(s) are chosen from In, Sn, Al, Pb, Hg, Bi, Ga, Cd, Hf, Ir, La, Li, Mo, Nb, Os, Pa, Re, Rh, Ru, Ta, Tc, Th, Ti, Tl, U, V, W, Zn, Zr, Au, Ag, Cu, Na, Ni, Fe, Co, and any combination thereof. In various examples, the semiconductor material(s) is/are chosen from crystalline inorganic semiconductor materials, amorphous inorganic semiconductor materials, organic polymer semiconductor materials, and any combination thereof In various examples, the ceramic material(s), the metal(s), the metal alloy(s), or the combination thereof are superconducting at a temperature above about 1 K. In various examples, the ceramic material(s) is/are chosen from LaBaCuO, LaSrCuO, YBa₂Cu₃O₇ (YBCO), Bi₂Sr₂Ca₂Cu₃O₁₀ (BSCCO), T1BaCaCuO, HgBaCaCuO, and Hg₁₂Tl₃Ba₁₀Ca₃₀Cu₄₅O₁₂₇, and any combination thereof. In various examples, the metal(s) or metal alloy(s) is/are chosen from Al, Ga, In, Pb, Nb, Nb₃Sn, and NbTi, Nb₃Ge, and any combination thereof.

In various examples, the BCP-derived material is monolithic, a free-standing film, or a film disposed on at least a portion of or all of a surface or all of the surfaces of a substrate. In various examples, the BCP-derived material comprises a ceramic material or a carbonaceous material. In various examples, the ceramic material is chosen from metal oxides, metal nitrides, metal carbides, metal oxynitrides, metal carbonitrides, and any combination thereof. In various examples, the carbonaceous material is chosen from graphitic carbon, amorphous carbon, nitrogen doped graphitic, amorphous carbon, and any combination thereof. In various examples, the BCP-derived template is a quantum confined material or exhibits one or more superconducting behavior(s). In various examples, the BCP-derived material and/or templated material exhibits atomic level order and/or mesoscale level order or the BCP-derived templated material and/or templated material exhibits atomic level disorder and/or mesoscale level disorder.

In various examples, the nanocomposite material comprises a plurality of interpenetrating networks, wherein the inorganic material(s), the organic material(s), or the combination thereof form one or more network(s) and BCP-derived template material(s) form one or more other network(s). In various examples, one or more (or all) of the individual network(s) provide(s) a continuous pathway throughout the three-dimensional volume of the nanocomposite material. In various examples, the inorganic material(s), the organic material(s), or the combination thereof defines a three-dimensional space corresponding to at least a part of or all of a cubic double gyroid matrix, a single gyroid matrix, a hexagonally packed cylinder matrix space, a hexagonally perforated lamellae space, an orthorhombic (O70) matrix, a double diamond matrix, an L₃ phase, or a Plumber's Nightmare matrix. In various examples, the BCP-derived material has the following structure: the majority volume of a double gyroid structure, the minority volumes of a double gyroid network structure, the minority volume of a single gyroid network structure, the majority volume of a hexagonal cylinder structure, the majority volume of the hexagonally perforated lamellar structure, the majority volume of the orthorhombic (O70) network structure, the minority volume of the orthorhombic (O70) network structure, the majority volume of the double diamond network structure, or the minority volumes of the double diamond network structure, and/or the one or more organic material(s) or the combination thereof occupy 60% or more of the void spaces of the BCP-derived material having the following structure: the minority volumes (there are two) of the double gyroid structure, the majority volume of the double gyroid network structure, the majority volume of the alternating (or single) gyroid network structure, the minority volume (i.e., the cylinder volume) of a hexagonal cylinder structure, the minority volume of the hexagonally perforated lamellar structure, the minority volume of the orthorhombic (O70) network structure, the majority volume of the orthorhombic (O70) network structure, the minority volumes of the double diamond network structure, the majority volume of the double diamond network structure, respectively.

In various examples, at least a portion of or all of the inorganic material(s), the organic material(s) or the combination thereof are crystalline and/or amorphous. In various examples, the BCP-derived material comprises insulating material(s) and/or semiconducting material(s) and/or conducting material(s) and/or superconducting material(s) and/or one or more or all of the templated materials(s) comprises insulating material(s) and/or semiconducting material(s) and/or conducting material(s) and/or superconducting material(s).

In various examples, the nanocomposite is a quantum confined material or exhibits one or more superconducting behavior(s).

In various examples, a composition comprises one or more three-dimensional inorganic materials(s), one or more organic material(s), or any combination thereof. In various examples, the composition is monolithic, a free-standing film, or a film disposed on at least a portion of or all of a surface or all of the surfaces of a substrate.

In various examples, at least a portion of or all of the inorganic material(s), the organic material(s), or the combination thereof is continuous or co-continuous. In various examples, the inorganic material(s), the organic material(s), or the combination thereof are symmetric or ordered inorganic material(s), symmetric or ordered material(s), or any combination thereof or asymmetric or disordered inorganic material(s), asymmetric or disordered organic material(s), or any combination thereof. In various examples, the inorganic material(s) are chosen from ceramic materials, amorphous glasses, semiconductor materials, metal(s), metal alloy(s), non-metal inorganic materials, and any combination thereof and/or the organic material(s) are chosen from polymers, oligomers, organic molecules having a molar mass of 500 g/mol or less, and any combination thereof. In various examples, the metal(s) are chosen from In, Sn, Al, Pb, Hg, Bi, Ga, Cd, Hf, Ir, La, Li, Mo, Nb, Os, Pa, Re, Rh, Ru, Ta, Tc, Th, Ti, Tl, U, V, W, Zn, Zr, Au, Ag, Cu, Na, Ni, Fe, Co, and any combination thereof. In various examples, the semiconductor materials are chosen from crystalline inorganic semiconductor materials, amorphous inorganic semiconductor materials, organic polymer semiconductor materials, and any combination thereof.

In various examples, the ceramic material(s), the metal(s), the metal alloy(s), or the combination thereof are superconducting at a temperature above about 1 K. In various examples, the ceramic material(s) are chosen from LaBaCuO, LaSrCuO, YBa₂Cu₃O₇ (YBCO), Bi₂Sr₂Ca₂Cu₃O₁₀ (BSCCO), TlBaCaCuO, HgBaCaCuO, and Hg₁₂Tl₃Ba₃₀Ca₃₀Cu₄₅O₁₂₇, and any combination thereof. In various examples, the metal(s) or metal alloy(s) are chosen from Al, Ga, In, Pb, Nb, Nb₃Sn, and NbTi, Nb₃Ge, and any combination thereof.

In various examples, at least a portion of or all of the inorganic material(s), the organic material(s) or the combination thereof are crystalline and/or amorphous. In various examples, the composition exhibits atomic level order and/or mesoscale level order or the composition exhibits atomic level disorder and/or mesoscale level disorder.

In various examples, the nanocomposite material comprises a plurality of interpenetrating networks. In various examples, the composition defines a three-dimensional space corresponding to at least a part of or all of a cubic double gyroid matrix, a single gyroid matrix, a hexagonally packed cylinder matrix space, a hexagonally perforated lamellae space, an orthorhombic (O70) matrix, or a double diamond matrix, or an L₃ phase. In various examples, the composition defines a space corresponding to 60% or more of the void spaces of: one or more majority volume(s) of a double gyroid structure, one or more minority volume(s) of a double gyroid network structure, a single gyroid network structure, a hexagonal cylinder structure, a hexagonally perforated lamellar structure, a minority volume of an orthorhombic network structure, a majority volume of an orthorhombic network structure), a minority volume of a double diamond network structure, a majority volume of a double diamond network structure.

In various examples, the composition comprises insulating material(s) and/or semiconducting material(s) and/or conducting material(s) and/or superconducting material(s). In various examples, the composition is a quantum confined material or exhibits one or more superconducting behavior(s).

In various examples, a device comprises one or more nanocomposit(es) and/or composition(s) of the present disclosure. In various examples, device is an electronic device, energy device, or a sensor.

### BRIEF DESCRIPTION OF THE FIGURES

For a fuller understanding of the nature and objects of the disclosure, reference should be made to the following detailed description taken in conjunction with the accompanying figures.

FIGS. 1A-1B show a schematic of a route to a periodically structured indium metal/silicon oxynitride (In/SiON) composite with double gyroid morphology: (FIG. 1A) A mixture of poly(isoprene-b-styrene-b-dimethylamino-ethylmethacrylate) (PI-b-PS-b-PDMAEMA, or simply ISA terpolymer) and poly(methyl vinyl silazane) (PMVS) undergoes evaporation induced self-assembly (EISA) at 40 degrees Celsius (° C.) to yield a double gyroid structured hybrid, which is then fired at 1000° C. in ammonia to yield a mesoporous ceramic template. The resulting SiON matrix is placed in a custom reactor with indium metal and heated to 250° C. under 400 Megapascals (1VIPa) of pressure, yielding a metal infiltrated gyroidal ceramic. (FIG. 1B) Rendering of the two interpenetrating minority networks of the double gyroid structure, that after high pressure processing are backfilled with indium metal. The cubic unit cell is shown.

FIGS. 2A-2B show small angle X-ray scattering (SAXS) and Nitrogen physisorption characterization of block copolymer composites, porous SiON templates, and/or indium infiltrated gyroidal In/SiON nanocomposities (FIG. 2A). Representative small angle X-ray scattering (SAXS) traces of the ISA/PMVS hybrid (bottom, solid line; d₁₀₀=125 nm), pyrolyzed SiON ceramic (middle, dashed line; d₁₀₀=73 nm), and indium infiltrated ceramic (top, dotted line; d₁₀₀=73 nm). Ticks above each pattern together with Miller indices show the first eight expected reflections for the Ia3̅d space group (#230) consistent with the double gyroid structure. Curves are vertically displaced for clarity. (FIG. 2B) Nitrogen adsorption and desorption isotherms for the double gyroidal SiON template via nitrogen gas (N₂) physisorption. Inset: pore size distribution calculated via the Barrett-Joyner-Halena (BJH) method for the mesoporous ceramic.

FIGS. 3A-3E show an energy dispersive x-ray spectroscopy (EDX) and scanning electron microscopy (SEM) characterization of an indium infiltrated mesoporous double gyroidal SiON. (FIG. 3A) SEM micrograph of an In/SiON composite cross section at low magnification. (FIG. 3B) EDX elemental map of the image depicted in FIG. 3A; areas with detectable indium are shaded in gray. (FIG. 3C) EDX photon counts in x-ray fluorescence energy ranges characteristic of indium (gray) and silicon (black) across the white line shown in FIG. 3B. (FIG. 3D) Back-scattered electron (BSE) micrograph of a polished In/SiON composite at a magnification that allows visualization of the double gyroidal structure. A higher magnification image of a separate area is shown in the inset (top right). (FIG. 3E) BSE micrograph of the polished composite showing a grain boundary between two mesoscale double gyroid domains (In regions appear bright, while SiON regions appear dark).

FIGS. 4A-4D show a vibrating sample magnetometry (VSM) and DC transport characterization of double gyroidal indium/SiON nanocomposite (left-right traces) and bulk indium (up-down traces) shown in FIGS. 4A-4B. (FIG. 4A) Magnetic moment measurements over temperatures near the critical temperature of indium. All measurements carried out in an external field of 8 millitesla (mT). Inset (bottom right): Rendering of interpenetrating indium metal minority networks in the SiON composite; the ceramic matrix is not shown to reveal minority network connectivity. (FIG. 4B) Magnetic moment measurements from 0 to 0.75 Tesla (T), with arrows depicting field scanning direction for both samples. Transport behavior of the indium/SiON nanocomposite as measured by four-point probe technique. (FIG. 4C) resistance measurements over a range of temperatures close to the superconducting transition temperature at different applied fields: 0 T, 1 T, and 2 T. (FIG. 4D) resistance measurements over a range of external field strengths at different sample temperatures: 2 Kelvin (K), 3 K, and 4 K. Inset: resistance measurements at 2 K at low field strengths.

FIG. 5 shows X-ray diffraction (XRD) traces for indium metal (bottom trace) used in the infiltration and indium metal/ceramic composite (top trace) after infiltration. Bottom tick marks show expected peak indices and positions for pure indium metal. It should be noted that in the case of both the bulk and mesostructured indium metal a high degree of sample texturing was seen, resulting in the large differences in relative peak intensities.

FIGS. 6A-6D show background subtraction of full magnetization loops of double gyroidal indium/SiON composites to isolate hysteretic component. (FIG. 6A) Raw field dependent magnetization of mesostructured indium at 2 K, 2.5 K, and 4 K showing significant non-hysteretic background signal above the double gyroidal indium critical temperature (T_{c}) of ≈3.67 K. (FIG. 6B) Background subtracted data at 2, 2.5, and 4 K obtained via subtraction of the 4 K trace multiplied by a temperature dependent fitting parameter. This prefactor was selected to minimize the summed square value of non-hysteretic magnetic signal at very high fields (e.g., ±about 1 T or higher and lower than about 1 T) and was seen to vary linearly with temperature. (FIG. 6C) Unsubtracted magnetization loop at 2 K and representative components of background signal: paramagnetic signal (dashed line), diamagnetic signal (dotted black trace), and combined background signal (solid line). (FIG. 6D) Background subtracted magnetization loop at 2 K, dotted lines added for visual guidance.

FIG. 7 shows magnetization measurements at low field for a 100 μm bulk indium foil, a double gyroidal indium sample measured less than 48 hours after infiltration, and the same double gyroidal indium sample measured after nine months of storage at room temperature in open air. All measurements were performed at 2 K after cooling under zero field. The green trace represents a subset of the data as shown in FIG. 4B. The very nearly overlapping traces from the ‘new’ as compared to ‘old’ material demonstrates a very high degree of stability and lack of sensitivity to oxidation.

FIGS. 8A-8B show observed critical fields for double gyroidal indium during field dependent magnetization at varying temperature as shown in FIGS. 6A-B. (FIG. 8A) Linear fit of the upper critical field with respect to the square of the temperature, used to determine upper critical field at zero temperature (H_{c2}(0)) and T_{c}. Black circles denote observed upper critical field at respective temperature, taken to be the point at which hysteresis disappeared in the raw data (shown in FIG. 6A) and the sample magnetic moment in both the forward and reverse field scanning direction matched within an instrumental margin of error. (FIG. 8B) Superconducting phase diagram for double gyroidal indium showing critical field with respect to temperature. Observed upper critical field again denoted by black circles, lower critical field estimated using the calculated effective κ shown as black crosses. Lines are of the form H_{c}(T)=H_{c}(0)·(1−(T/T_{c})² for guidance; μ₀H_{c1}(0) estimated as 0.82 T using the relation H_{c1}=H_{c2}2κ²·1n(κ).

FIGS. 9A-9C show a visualization of confinement within the network struts of a core shell double gyroid structure. (FIG. 9A) A model volume used for Monte Carlo sampling of ballistic paths, spanning three Ia3̅d unit cells in the x, y, and z dimensions. The shaded volume represents both the left- and right-handed strut networks at a combined volume fraction of 0.288 of the unit cell volume. Lines drawn within this shaded volume denote randomly sampled straight paths. Black outlines denote the boundaries of one cubic unit cell. (FIG. 9B) A larger depiction of a single Ia3̅d unit cell, with the strut network shaded volume and sampled paths drawn in as lines. Black borders again denote the edges of the unit cell. (FIG. 9C) A histogram showing the distribution of 4,446 randomly sampled paths within the volume shown in FIG. 9B, with an average path length of 23 nm.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations and variations in the alternatives are appropriate to perform in the instant disclosure . As used herein, the terms “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent, trivalent, and the like, radicals). Illustrative examples of groups include:

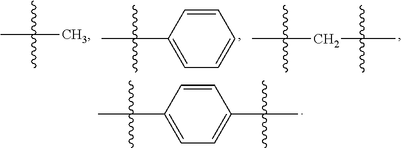

The present disclosure describes methods of making templated materials, nanocomposite materials, and compositions. The present disclosure also describes uses of the nanocomposites and materials.

In an aspect, the present disclosure provides methods of making templated materials. In various examples, a method produces a nanocomposite material or a composition of the present disclosure. In various examples, a method does not produce a solid wire. Non-limiting examples of nanocomposite materials are disclosed herein.

Non-limiting examples of methods of making templated materials are disclosed herein.

A method of making a templated material may comprise contacting one or more inorganic material(s) and/or one or more organic material(s), or a combination thereof (which may be in the form of a melt or the like) with a block copolymer (BCP)-derived template defining a three-dimensional space (which may be referred to as a void space) (at least a portion of or all of which may be continuous or co-continuous), where the one or more or more inorganic material(s) and/or one or more organic material(s), or a combination thereof is under pressure (e.g., a pressure greater than ambient pressure), and one or more inorganic material(s) and/or one or more organic material(s) at least partially, substantially, or completely fills (e.g., occupies, infiltrates, or the like) the three-dimensional space (which may be referred to as a templated space) forming a templated material (which taken with the BCP-derived template forms a product (which may be a nanocomposite material).

In various examples, a method of making a templated material comprises contacting one or more inorganic material(s) and/or one or more organic material(s), or a combination thereof (which may be in the form of a melt or the like) with a block copolymer (BCP)-derived template defining a three-dimensional space (which may be referred to as a void space) (at least a portion of or all of which may be continuous or co-continuous). In various examples, the one or more or more inorganic material(s) and/or one or more organic material(s), or a combination thereof that is contacted with the BCP-derived template is under pressure (e.g., a pressure greater than ambient pressure) (or a pressure is applied to the inorganic material(s) and/or organic material(s), or the combination thereof), and one or more inorganic material(s) and/or one or more organic material(s) at least partially, substantially, or completely fills (e.g., occupies, infiltrates, or the like) the three-dimensional space (which may be referred to as a templated space) forming a templated material (which taken with the BCP-derived template forms a product (which may be a nanocomposite material). In various examples, the contacting and applying pressure is at the same time, substantially the same time, or in discrete processes.

A BCP-derived template can comprise various materials (BCP-derived template materials) and combinations of materials. In various examples, a BCP-derived template comprises insulating material(s) and/or semiconducting material(s) and/or conducting material(s) and/or superconducting material(s). In various examples, one or more or all of the templated material(s) comprises insulating material(s) and/or semiconducting material(s) and/or conducting material(s) and/or superconducting material(s). In various examples, a BCP-derived template comprises insulating material(s) and/or semiconducting material(s) and/or conducting material(s) and/or superconducting material(s) and/or one or more or all of the templated materials(s) comprises insulating material(s) and/or semiconducting material(s) and/or conducting material(s) and/or superconducting material(s).

A BCP-derived template may be formed from a self-assembled BCP-derived structure. In various examples, a self-assembled BCP-derived structure undergoes isotropic shrinkage on thermal treatment (e.g., thermal treatment resulting in formation of a BCP-derived template, such as, for example, a ceramic BCP-derived template or the like) to form a BCP-derived template.

BCP-derived templates may be made by methods known in the art. Various block copolymers or combinations of block copolymers can be used to form the BCP-derived template. In various examples, a BCP-derived template is made using one or more swelling agents(s). It is considered that any self-assembling block copolymer can be used.

Non-limiting examples of block copolymers include polyethylene oxide-block-polypropylene oxide-block-polyethylene oxide (e.g., the commercially available Pluronics family of ABA block copolymers and the like), polyisoprene-block-polyethylene oxide, polyisoprene-block-polydimethylaminoethyl methacrylate, polystyrene-block-polyethylene oxide, polystyrene-block-polydimethylaminoethyl methacrylate, polyisoprene-block-polystyrene-block-polyethylene oxide, polyisoprene-block-polystyrene-block-polydimethylaminoethyl methacrylate, and the like, and any combination thereof. Non-limiting examples of block copolymers include those described in U.S. Pat. Nos. 9,714,173, 6,645,626, U.S. Pub. Pat. Appl. No. 2011/0027572, and U.S. Pub. Pat. Appl. No. 2011/0130478, the disclosure of which with regard to block copolymers is incorporated herein by reference.

A BCP-derived template can comprise or be various materials or combinations of materials. A BCP-derived template may comprise or be a ceramic material or a carbonaceous material. The ceramic or carbonaceous material may be formed by thermal treatment (which may include removal of at least a portion of, substantially all, or all of the organic material(s), densification, solid state chemical transformation (e.g., conversion of an oxide to, for example, a nitride, carbide, or the like, or any combination thereof), or the like, or any combination thereof) of a self-assembled block copolymer, optionally, in combination with an organic additive (e.g., an additive that forms an inorganic material and/or a carbonaceous material on thermal treatment) and/or inorganic additive (e.g., an additive that forms an inorganic material on thermal treatment) or a combination thereof. Non-limiting examples of ceramic and carbonaceous materials include oxides (e.g., metal oxides, TiO₂, Nb₂O₅, Al₂O₃, SiO₂ and the like), nitrides (e.g., metal nitrides, TiN, NbN, AlN, SiN, and the like), carbides (e.g., TiC, NbC, SiC, and the like), oxynitrides (e.g., metal oxinitrides, TiON, NbON, AlON, SiON, and the like), carbonitrides (e.g., TiCN, NbCN, SiCN, and the like) carbon materials (e.g., graphitic carbon, amorphous carbon, nitrogen doped graphitic, amorphous carbon, and the like), and the like, and any combination thereof.

As an illustrative example, organic resols are combined with the block copolymer(s), which upon thermal treatment is converted into carbonaceous materials. As another illustrative example, organic additive is combined with the block copolymer(s), which upon thermal treatment is converted to an inorganic material. For example, a polymer additive (which may be a preceramic additive, such as, for example, a polysilazane or the like) is converted into a mesoporous inorganic ceramic (e.g., a silicon carbide, silicon oxycarbide, or the like) upon thermal treatment. The resulting material may be referred to as a BCP-derived material.

A BCP-derived template may be superconducting (e.g., a superconducting ceramic material or the like). In various examples, a superconducting BCP-derived template exhibits an abrupt decrease in resistivity at a critical temperature, magnetic flux exclusion at a critical temperature, or the like, or a combination thereof. Non-limiting examples of superconducting materials include niobium nitrides, niobium carbonitrides, titanium nitrides, titanium carbonitrides and the like. The BCP-derived template may be a quantum confined material. The BCP-derived template may exhibit superconducting behavior. Non-limiting examples of superconducting behavior include an increased critical field, an increased critical current, an increased critical temperature, a change in magnetization hysteresis, an increase in magnetic flux pinning, an observed change in characteristic parameters, and the like, and any combination thereof relative to the bulk BCP-derived template material.

A BCP-derived template is porous. In various examples, the BCP-derived template is mesoporous. The BCP-derived template has continuous porosity or pore volume with at least one external/surface access point.

A BCP-derived template can have various forms and/or sizes. The BCP-derived template may be a three-dimensional object. The BCP template may be monolithic. A monolithic BCP template may be free-standing. The BCP-derived template (or at least a portion thereof) is continuous or co-continuous (e.g., bi-continuous, tri-continuous, or the like), with at least one external/surface access point.

The BCP-derived template may be a film, which may be disposed on at least a portion of or all of a surface or all of the surfaces of a substrate. A film may be a free-stranding film.

In various examples, the BCP-derived template has a thickness of 20 nm to 5 mm and/or a longest linear dimension of up to 30 cm or greater. In various examples, a BCP-derived template has an area of up to 900 square centimeters or greater. Of course, BCP-derived templates having greater thickness and/or longest linear dimensions and/or areas are envisioned.

The three-dimensional space may define a variety of shapes. At least a portion of all of the three-dimensional space may be continuous or co-continuous (e.g., bi-continuous, tri-continuous, or the like). The three-dimensional space may be a symmetric/isotropic three-dimensional space or an asymmetric/disordered space. The three-dimensional space may be an ordered space or disordered space. In various examples, the three-dimensional space is a cubic double gyroid matrix and/or matrix space, a single (alternating) gyroid matrix and/or network space, a hexagonally packed cylinder matrix space, a hexagonally perforated lamellae space, an orthorhombic matrix and/or network space, a double diamond matrix and/or network space, an L₃ phase (e.g., L₃ a disordered phase or the like), or the like.

A BCP-derived template material may have mesostructure corresponding to the three-dimensional space, which is periodically ordered and/or disordered (e.g., mesoscale amorphous domain(s), mesoscale crystalline domain(s) (which may be mesoscale single crystalline domain(s), mesoscale polycrystalline domain(s), or the like or a combination thereof), and/or atomic-scale order and/or disorder (e.g., amorphous domain(s), crystalline domain(s) (which may be single crystalline domain(s), polycrystalline domain(s), or the like or a combination thereof), or the like, or any combination thereof). One or more or all of the domains may be mesoscale domains as defined by IUPAC.

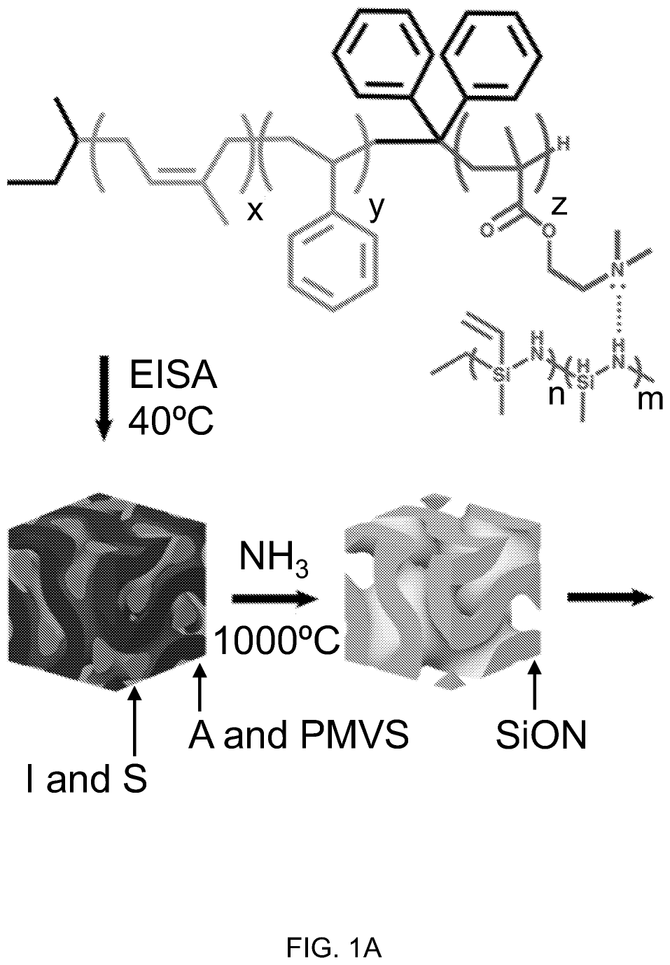

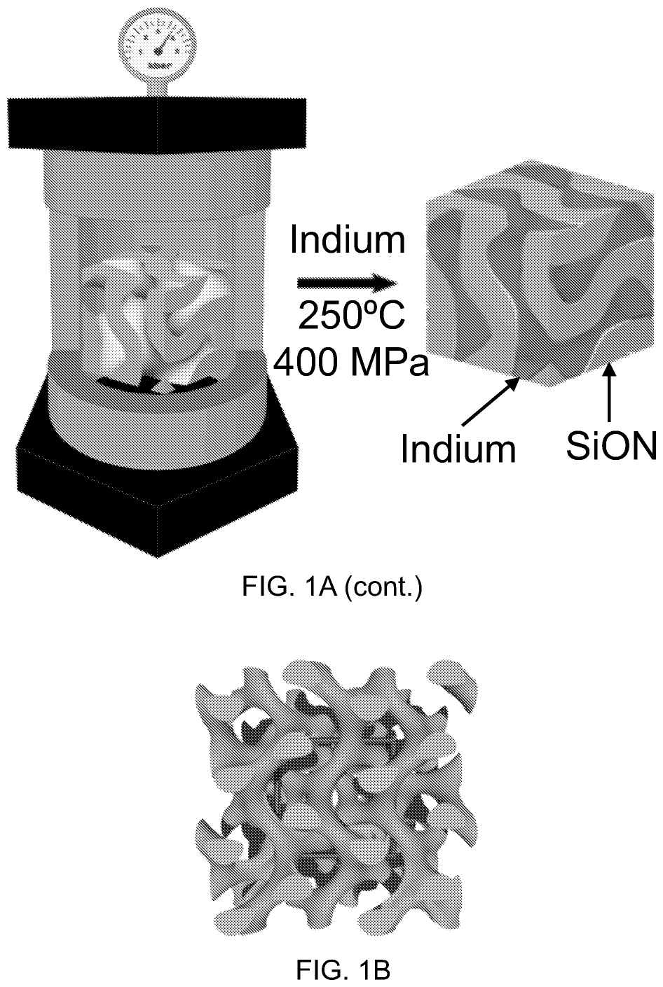

A BCP-derived template may comprise a plurality of interpenetrating networks (e.g., one or more void space networks (which individually or taken together may be majority or minority networks) and/or one more BCP-derived material (e.g., ceramic material or the like) network(s) (which individually or taken together are majority or minority networks). In a product, at least a portion of or all of the void space network(s) are filled with templated material(s). In various examples, one or more (or all) of the individual network(s) provide(s) a continuous pathway (e.g., an electrical conduction pathway or the like) throughout the three-dimensional volume of the BCP-derived template. As an illustrative example (e.g., as shown in FIG. 1B of the Example), the BCP-derived material (e.g., ceramic material or the like) has a double gyroid structure (which may be described as a co-continuous mesoporous (cubic) structure) as both the BCP-derived material and the void space are continuous in three-dimensional (3D) space (the 3D co-continuous structure of these gyroids may be described as network structures). The void space of the double gyroid may comprise of two independent minority void spaces (indicated by the two minority volumes in FIG. 1B of the example) that penetrate each other and, at the same time, penetrate the majority volume occupied by the BCP-derived material (e.g., ceramic material) (not shown in FIG. 1B), the BCP-derived material at least partially or completely fills the free space in between the minority networks (e.g., two minority networks shown in FIG. 1B). The templated material (e.g., the indium metal in FIG. 1B) at least partially or completely fills the void space (e.g., the two minority void/network spaces shown in FIG. 1B). The product (templated material taken with the BCP-derived template, which may be referred to as a nanocomposite material, comprises two different materials that form three independent networks that interpenetrate each other (e.g., the two minority network spaces are filled with templated material(s), such as, for example, metal(s) and the majority volume in between the two minority network spaces is BCP-derived template material (e.g., ceramic material or the like).

In various examples, the BCP-derived template has the following structure:
the majority (matrix) volume of the double gyroid structure,
the minority volumes of the double gyroid network structure,
the minority volume (no plural here) of the alternating (or single) gyroid network structure,
the majority (matrix) volume of a hexagonal cylinder structure,
the majority (matrix) volume of the hexagonally perforated lamellar structure,
the majority (matrix) volume of the orthorhombic (O70) network structure,
the minority volume of the orthorhombic (O70) network structure,
the majority (matrix) volume of the double diamond network structure,
the minority volumes of the double diamond network structure, or the like.

A BCP template can be formed by various processes. A BCP-derived template may be formed using film forming processes (e.g., roll-to-roll processes, spin-coating, doctor-blading, drop-casting, spray-coating, and the like), 3-D printing, extrusion, molding, and the like.

A templated material can be formed using various inorganic materials and/or organic materials. It is considered that a variety of inorganic materials and/or organic materials can be used (e.g., used for infiltration) to form a templated material. It is desirable that the inorganic material(s) and/or organic material(s), or combination thereof be able to impregnate the BCP-derived template and/or do/does not react (e.g., reduce one or more component(s) of the template or the like) and/or is able to impregnate the BCP-template at a temperature (e.g., about, at, or at or above the melting or glass transition point or half of the melting or glass transition point of the inorganic material(s) and/or organic material(s), or combination thereof or is a liquid or a solid at one-half of the melting or glass transition point of inorganic material(s) and/or organic material(s), or combination thereof) that does not adversely affect the BCP-template. The templated material may be templated inorganic materials(s), templated organic material(s), or a combination thereof. In various examples, a templated inorganic material or material(s) is/are formed from the inorganic material(s). In various examples, a templated organic material or material(s) is/are formed from the organic material(s).

The inorganic material(s) and/or organic material(s), or combination thereof may be a liquid. The inorganic material(s) and/or organic material(s), or combination thereof may be a solid at a temperature about or at or above one half of the melting point or glass transition of the inorganic material(s) (e.g., ceramic material(s), amorphous glass(es), semiconductor material(s), metal(s), metal alloy(s), non-metal inorganic material(s) ceramic material(s), metal(s), metal alloy(s), or the like) and/or organic material(s) (e.g., polymer material(s), oligomeric material(s), low molar mass (e.g., 500 g/mol or less, 250 g/mol or less, or 100 g/mol or less) organic material(s), or the like).

In various examples, the inorganic material(s) (which may be referred to in the alternative as templated inorganic material(s)) are chosen from ceramic materials, amorphous glasses, semiconductor materials, metals, metal alloys, non-metal inorganic materials, and the like, and any combination thereof) and/or the organic material(s) (which may be referred to in the alternative as templated organic material(s)) are chosen from polymers, oligomers, and low molar mass (e.g., 500 g/mol or less, 250 g/mol or less, or 100 g/mol or less) organic molecules, and any combination thereof. Non-limiting examples of inorganic materials include ceramic materials, amorphous glasses, semiconductor materials, metal(s), metal alloy(s), non-metal inorganic materials, and the like, and any combination thereof. Non-limiting examples of semiconductor materials include crystalline inorganic semiconductor materials (such as, for example, Si, Ge, GaAs, and the like, and any combination thereof), amorphous inorganic semiconductor materials (such as, for example, a-In-Ga-Zn-O (or a-IGZO), a-zinc silicate (a-ZSO), and the like, and any combination thereof), semicrystalline organic polymer semiconductor materials (such as, for example, poly-thiophenes, polyanilines and the like), and the like, and any combination thereof. Non-limiting examples of metals include In, Sn, Al, Pb, Hg (e.g., alpha-Hg, beta-Hg, or the like), Bi, Ga, Cd, Hf, Ir, La (e.g., alpha-La, beta-La, or the like), Li, Mo, Nb, Os, Pa, Re, Rh, Ru, Ta, Tc, Th (e.g., alpha-Th or the like), Ti, Tl, U (e.g., alpha-U, beta-U, or the like), V, W (e.g., alpha-W, beta-W, or the like), Zn, Zr, Au, Ag, Cu, Na, Ni, Fe, Co, and any combination thereof (e.g., an alloy or the like) or compounds (e.g., sulfide, nitride, oxide, or the like) thereof

An inorganic material may be a superconducting material. In various examples, an inorganic material is superconducting at a temperature above about 1 K or about 5 K (e.g., about 1 K to about 150 K, about 10 K to about 100 K, or about 60 K to about 150 K, including all 0.1 K values and ranges therebetween). In various examples, a ceramic material (which may be nano and/or mesostructured) is superconducting at a temperature above about 20 K (e.g., about 30 K to about 150 K). Non-limiting examples of superconducting ceramic materials include copper oxides (cuprates), such as, for example, LaBaCuO, LaSrCuO, YBaₓCu_{y}O_{z} (e.g., YBa₂Cu₃O₇ (YBCO) and the like), BiᵣSrₛCaₜCuᵥO_{w} (e.g., Bi₂Sr₂Ca₂Cu₃O₁₀ (BSCCO) and the like), TlBaCaCuO, HgBaCaCuO, and HgₐTl_{b}Ba_{c}Ca_{d}Cu_{c}O_{f} (e.g., Hg₁₂Tl₃Ba₃₀Ca₃₀Cu₄₅O₁₂₇ and the like), and the like. In various examples, a metal or metal alloy (which may be nano and/or mesostructured) is superconducting at a temperature above about 1 K or about 5 K (e.g., about 5 K to about 40 K). Non-limiting examples of superconducting metals and metal alloys include Al, Ga, In, Pb, Nb, Nb₃Sn, NbTi, Nb₃Ge, and the like. In various examples, an inorganic material (which may be nano and/or mesostructured) is an iron-based superconducting material and is superconducting at a temperature above about 10 K (e.g., about 10 K to about 60 K). Non-limiting examples of iron-based superconducting materials include LaOFFeAs, SrFFeAs, FeSe, and the like. In various examples, an inorganic material (which may be nano and/or mesostructured) is a magnesium-based superconducting material and is superconducting at a temperature above about 30 K (e.g., about 30 K to about 50 K). Non-limiting examples of magnesium-based superconducting materials include magnesium diboride (MgB₂) and the like.

At least a portion of or all of the inorganic material(s) and/or organic material(s), or combination thereof may be crystalline (e.g., having at least one crystalline domain, polycrystalline, single crystalline, or the like). At least a portion of or all of the inorganic material(s) and/or organic material(s), or combination thereof may be amorphous (e.g., having at least one amorphous domain). At least a portion of or all of the inorganic material(s) and/or organic material(s), or combination thereof may be crystalline (e.g., having at least one crystalline domain, polycrystalline, single crystalline, or the like) and at least a portion of or all of the inorganic material(s) and/or organic material(s), or combination thereof may be amorphous (e.g., having at least one amorphous domain).

A BCP-derived templated material and/or templated material may exhibit crystalline order. The order may be atomic level order and/or mesoscale level order. By atomic level crystalline order it is meant crystalline order at the atomic level (e.g., periodically ordered lattice of atoms, such as, for example, cubic or the like). Atomic level crystalline order may be determined by, for example, wide-angle x-ray scattering, WAXS, or the like. By mesoscale level crystalline order it is meant crystalline order at the mesoscale level (e.g., a periodically ordered lattice at the mesoscale, such as, for example, cubic double gyroid or the like) (e.g., as described by as defined by IUPAC). Mesoscale level crystalline order may be determined by, for example, small angle x-ray scattering, SAXS.

A BCP-derived templated material and/or templated material may exhibit disorder. The disorder may be atomic level disorder and/or mesoscale level disorder. By atomic level disorder (which may be referred to as a glass) it is meant that there is no period lattice that can be used to describe the relative positions of atoms. By mesoscale level disorder (which may be referred to as disordered mesostructured), it is meant that there is no underlying lattice that can be used to describe the structure at the mesoscale (e.g., as described by as defined by IUPAC).

Pressure is applied to the inorganic material(s) and/or organic material(s), or the combination thereof which are in contact with the BCP-derived template. In various examples, the inorganic material(s) and/or organic material(s), or the combination thereof is/are under pressure during at least a portion of or all of the contacting with the BCP-derived template. It may be desirable to use at least a pressure that overcomes the surface tension of the melt of the inorganic material(s) and/or organic material(s). In various examples, the pressure is greater than the ambient pressure (e.g., greater than about 1 atm or the like). In various examples, the pressure is from about 1 atm to about 10⁴ atm (e.g., about 1.5 atm to about 10⁴ atm, about 2 atm to about 10⁴ atm, about 5 atm to about 10⁴ atm, about 10 atm to about 10⁴ atm, about 50 atm to about 10⁴ atm, or about 100 atm to about 10⁴ atm), including all 0.1 atm values and ranges thereof. As an illustrative example, the pressure used is in excess of about 1,000 atm in the case of indium metal. The pressure may be provided by a gas, a fluid (which may be a non-compressible or substantially non-compressible fluid), a liquid, or the like. The gas may be an inert gas, such as, for example, helium, argon, nitrogen, or the like. It is desirable that the gas(es) or fluid(s) do not chemically react with or dissolve the inorganic material(s) and/or organic material(s) and/or BPC template. The pressure may be a mechanical pressure (e.g., created using a mechanical device or the like).

After a desired time or after a desired filling (e.g., occupying, infiltrating, or the like) of the inorganic material(s) and/or organic material(s), or the combination thereof the pressure is removed from the inorganic material(s) and/or organic material(s), or the combination thereof. In various examples, the inorganic material(s) and/or organic material(s), or the combination thereof that infiltrate the BCP derived template have a desired structure (e.g., desired pore structure, desired order or lack thereof, desired crystalline structure or lack thereof, or the like, or a combination thereof), which may be the structure of the inorganic material(s) and/or organic material(s), or the combination thereof prior to subjecting the inorganic material(s) and/or organic material(s), or the combination thereof to the pressure.

The inorganic material(s) and/or organic material(s), or combination thereof can be subjected to (or at) various temperatures when the inorganic material(s) and/or organic material(s), or combination thereof is/are under pressure. It may be desirable to contact (e.g., infiltrate) inorganic materials at half of their melting point or glass transition.

In various examples, the inorganic material(s) and/or organic material(s), or the combination thereof are contacted with the BCP-derived template as a melt (e.g., heated to form a melt) and then subjected to a pressure such that the inorganic material(s) and/or organic material(s), or the combination thereof fill (e.g., occupy, infiltrate, or the like) at least a portion, substantially all, or all of the BCP-derived template.

A method may further comprise removing at least a portion, substantially all, or all of the BCP-derived template. In various examples, removal of substantially all, or all of the BCP-derived template produces a composition of the present disclosure. A method may further comprise removing at least a portion, substantially all, or all of the BCP-derived template. A BCP-derived template may be removed by methods known in the art. It is considered that any process typically used to remove ceramic materials may be used to remove a portion, substantially all, or all of the BCP-derived template. In various examples, the BCP-derived template is removed by a chemical etch, which may be a gas and/or a liquid chemical etch, such as, for example, an acid based (e.g., HF or the like) etch, a base based etch, a plasma etch, or the like. It is desirable that chemicals used to remove the BCP-derived template not adversely affect the templated material.

A method may further comprise annealing the BCP-derived template and templated material (e.g., the nanocomposite) or the templated material before or after removal of at least a portion, substantially all, or all of the BCP-derived template. The annealing may be a thermal annealing. The temperatures used may be from half the melting or softening point of the templated material to above the melting temperature of the templated materials. The annealing may be performed in vacuum or in gas not limited to nitrogen, argon, helium, hydrogen, ammonia, methane, or a combination thereof. The annealing may be performed by means such as, for example, zone refining, isothermal annealing, or the like.

A method may further comprise one or more post BCP-derived template and templated material (e.g., nanocomposite) formation process(es). Nonlimiting examples of post BCP-derived template and templated material (e.g., nanocomposite) formation processes include polishing, cutting or otherwise shaping, which may be carried out to determine the macroscopic shape and dimension of the BCP-derived template and templated material (e.g., nanocomposite), and the like, and any combination thereof.

A method may further comprise contacting of the BCP-derived template and templated material (e.g., nanocomposite) with electrically conductive materials (e.g., an electrode material, an electrode, or the like). Nonlimiting examples of electrically conductive materials include graphitic materials, metals, conductive polymers, and the like, and any combination thereof.

A method can produce various templated materials. The templated material may be templated inorganic materials(s), templated organic material(s), or a combination thereof. In various examples, a templated inorganic material or material(s) is/are formed from the inorganic material(s). In various examples, a templated organic material or material(s) is/are formed from the organic material(s). The templated material may be a quantum confined material. The templated material may be superconducting. In various examples, a superconducting templated material exhibits an abrupt decrease in resistivity at a critical temperature, magnetic flux exclusion at a critical temperature, or the like, or a combination thereof. The templated material may exhibit superconducting behavior. Non-limiting examples of superconducting behavior include an increased critical field, an increased critical current, an increased critical temperature, a change in magnetization hysteresis, an increase in magnetic flux pinning, an observed change in characteristic parameters, and the like, and any combination thereof relative to the bulk templated material(s) (the bulk the inorganic material(s) and/or organic material(s)).

The templated material may be or substantially be a negative of the BCP-derived template. By “substantially a negative” it is meant that the templated material fills (e.g., infiltrates) 60% or more, 70% or more, 80% or more, 90% or more, 95% or more, 98% or more, or 99% or more of the internal three-dimensional void space defined by the BCP-derived template.

At least a portion of or all of the templated material (e.g., templated inorganic material(s) and/or templated organic material(s), or a combination thereof) may be crystalline (e.g., having at least one crystalline domain, polycrystalline, single crystalline, or the like). At least a portion of or all of the inorganic material(s) and/or organic material(s) may be crystalline (e.g., having at least one crystalline domain, polycrystalline, single crystalline, or the like) and at least a portion of or all of the inorganic material(s) and/or organic material(s) may be amorphous (e.g., having at least one amorphous domain). At least a portion of or all of the inorganic material(s) and/or organic material(s) may be amorphous (e.g., having at least one amorphous domain).

In various examples, at least a portion of or all of a BCP-derived template material and/or at least a portion of or all of one or more or all of the templated materials is:
atomically disordered (e.g., a glass or the like) and disordered at the mesoscale,
atomically ordered and disordered at the mesoscale,
atomically disordered and mesoscale ordered,
atomically ordered and mesoscale ordered, or the like, or a combination thereof.
   In these examples, the BCP-derived template material has the same mesoscale order as the templated material. In each example, for the atomic level and/or mesoscale level, the order may be at least partially or completely polycrystalline (e.g., powder-like order or the like) or at least partially or completely single crystalline. As an illustrative example, at least a portion of or all of the BCP-derived template material has a locally disordered structure (e.g., a non-crystalline SiCN ceramic or the like) with an ordered gyroidal mesostructure, where the gyroidal lattice is polycrystalline or single crystalline. In this example, at least a portion of or all of the templated material may be atomically amorphous (e.g., a glass or the like) or atomically ordered/crystalline (e.g., polycrystalline or single crystalline).

In an aspect, the present disclosure provides nanocomposite materials. In various examples, a nanocomposite material is made by a method of the present disclosure. In various examples, a nanocomposite material (or the inorganic material(s), the organic material(s), or a combination thereof defining a three-dimensional space) is not a solid wire. In various examples, a nanocomposite material is not made by (or using) electrodeposition or electroless deposition. Non-limiting examples of nanocomposite materials are disclosed herein.

A nanocomposite material may comprise one or more inorganic material(s), one or more organic material(s) or a combination thereof defining a three-dimensional space and a BCP-derived material (which may be a thermally treated BCP material). The BCP-derived material is disposed on at least at a portion of or substantially all of a surface or surfaces of the inorganic material(s), organic material(s), or a combination thereof. In various examples, the BCP-derived material is a BCP-derived template or a BCP-derived template material and the one or more inorganic material(s), one or more organic material(s) or a combination thereof are templated materials. By “substantially all” it is meant that the BCP-derived material is disposed on at least a portion of or substantially all of the surfaces of the three-dimensional inorganic material(s), organic material(s), or a combination thereof except for at least a portion of or all of the exterior apertures of the BCP-derived material. At least a portion of all of the inorganic material(s), organic material(s), or a combination thereof may be continuous or co-continuous (e.g., bi-continuous, tri-continuous, or the like).

At least a portion of or all of the inorganic material(s), organic material(s) or a combination thereof may be amorphous (e.g., having at least one amorphous domain). At least a portion of or all of the inorganic material(s), organic material(s) or a combination thereof may be multigranual (e.g., comprise a plurality of grains). The grains individually may be anisotropic or preferentially oriented. At least a portion of or all of the inorganic material(s), organic material(s) or a combination thereof may be crystalline (e.g., having at least one crystalline domain, polycrystalline, single crystalline, or the like) and at least a portion of or all of the metal(s) may be amorphous (e.g., having at least one amorphous domain). At least a portion of or all of the inorganic material(s) and/or organic material(s), or combination thereof may be crystalline (e.g., having at least one crystalline domain, polycrystalline, single crystalline, or the like). At least a portion of or all of the inorganic material(s) and/or organic material(s), or combination thereof may be amorphous (e.g., having at least one amorphous domain). At least a portion of or all of the inorganic material(s) and/or organic material(s), or combination thereof may be crystalline (e.g., having at least one crystalline domain, polycrystalline, single crystalline, or the like) and at least a portion of or all of the metal(s) may be amorphous (e.g., having at least one amorphous domain).

A nanocomposite can comprise various inorganic materials and organic materials, and combinations thereof. Non-limiting examples of inorganic materials include ceramic materials, amorphous glasses, semiconductor materials, metals, metal alloys, non-metal inorganic materials, and the like, and any combination thereof.

Non-limiting examples of organic materials include polymers, oligomers, and low molar mass (e.g., 500 g/mol or less, 250 g/mol or less, or 100 g/mol or less) organic molecules, and the like, and any combination thereof. Non-limiting examples of semiconductor materials include crystalline inorganic semiconductor materials (such as, for example, Si, Ge, GaAs, and the like, and any combination thereof), amorphous inorganic semiconductor materials (such as, for example, a-In-Ga-Zn-O (or a-IGZO), a-zinc silicate (a-ZSO), and the like, and any combination thereof), semicrystalline organic polymer semiconductor materials (such as, for example, poly-thiophenes, polyanilines and the like), and the like, and any combination thereof. Non-limiting examples of metals include In, Sn, Al, Pb, Hg (e.g., alpha-Hg, beta-Hg, or the like), Bi, Ga, Cd, Hf, Ir, La (e.g., alpha-La, beta-La, or the like), Li, Mo, Nb, Os, Pa, Re, Rh, Ru, Ta, Tc, Th (e.g., alpha-Th or the like), Ti, Tl, U (e.g., alpha-U, beta-U, or the like), V, W (e.g., alpha-W, beta-W, or the like), Zn, Zr, Au, Ag, Cu, Na, Ni, Fe, Co, and any combination thereof (e.g., an alloy or the like) or compounds (e.g., sulfide, nitride, oxide, or the like) thereof.

An inorganic material may be a superconducting material. In various examples, an inorganic material is superconducting at a temperature above about 1 K or about 5 K (e.g., about 1 K to about 150 K, about 10 K to about 100 K, or about 60 K to about 150 K, including all 0.1 K values and ranges therebetween). In various examples, a ceramic material (which may be nano and/or mesostructured) is superconducting at a temperature above about 20 K (e.g., about 30 K to about 150 K). Non-limiting examples of superconducting ceramic materials include copper oxides (cuprates), such as, for example, LaBaCuO, LaSrCuO, YBaₓCu_{y}O₂ (e.g., YBa₂Cu₃O₇ (YBCO) and the like), BiᵣSrₛCaₜCuᵥO_{w} (e.g., Bi₂Sr₂Ca₂Cu₃O₁₀ (BSCCO) and the like), TlBaCaCuO, HgBaCaCuO, and HgₐTl_{b}Ba_{c}Ca_{d}CuₑO_{f} (e.g., Hg₁₂Tl₃Ba₃₀Ca₃₀Cu₄₅O₁₂₇ and the like), and the like. In various examples, a metal or metal alloy (which may be nano and/or mesostructured) is superconducting at a temperature above about 1 K or about 5 K (e.g., about 5 K to about 40 K). Non-limiting examples of superconducting metals and metal alloys include Al, Ga, In, Pb, Nb, Nb₃Sn, NbTi, Nb₃Ge, and the like. In various examples, an inorganic material (which may be nano and/or mesostructured) is an iron-based superconducting material and is superconducting at a temperature above about 10 K (e.g., about 10 K to about 60 K). Non-limiting examples of iron-based superconducting materials include LaOFFeAs, SrFFeAs, FeSe, and the like. In various examples, an inorganic material (which may be nano and/or mesostructured) is a magnesium-based superconducting material and is superconducting at a temperature above about 30 K (e.g., about 30 K to about 50 K). Non-limiting examples of magnesium-based superconducting materials include magnesium diboride (MgB₂) and the like.

The inorganic material(s), organic material(s), or a combination thereof defining a three-dimensional space may have a variety of shapes. The inorganic material(s), organic material(s), or a combination thereof may be symmetric/isotropic or symmetric /ordered inorganic material(s), organic material(s), or a combination thereof or an asymmetric/disordered inorganic material(s), organic material(s), or a combination thereof. In various examples, the symmetric inorganic material(s), symmetric organic material(s), or a combination thereof comprise a substantially homogeneous or homogeneous pore structure. In various examples, the asymmetric inorganic material(s), symmetric organic material(s), or a combination thereof comprise macropores and micropores and/or a gradient pore structure. The inorganic material(s), organic material(s), or a combination thereof may be an ordered inorganic material(s), organic material(s), or a combination thereof or disordered inorganic material(s), organic material(s), or a combination thereof. In various examples, the ordered inorganic material(s), ordered organic material(s), or a combination thereof exhibit long range order. In various examples, the disordered inorganic material(s), disordered organic material(s), or a combination thereof cannot be described by a lattice. In various examples, the inorganic material(s), organic material(s), or a combination thereof is (or is 60% or more, 70% or more, 80% or more, 90% or more, 95% or more, 98% or more, or 99% or more of) or defines a three-dimensional space corresponding to at least a part of (e.g., 60% or more, 70% or more, 80% or more, 90% or more, 95% or more, 98% or more, or 99% or more) or all of a cubic double gyroid matrix and/or matrix space, a single (alternating) gyroid matrix and/or network space, a hexagonally packed cylinder matrix space, a hexagonally perforated lamellae space, an orthorhombic matrix and/or network space, a double diamond matrix and/or network space, or the like.

In various examples, a BCP-derived material comprises insulating material(s) and/or semiconducting material(s) and/or conducting material(s) and/or superconducting material(s). In various examples, one or more or all of the templated materials comprises insulating material(s) and/or semiconducting material(s) and/or conducting material(s) and/or superconducting material(s). In various examples, a BCP-derived material comprises insulating material(s) and/or semiconducting material(s) and/or conducting material(s) and/or superconducting material(s) and/or one or more or all of the templated materials(s) comprises insulating material(s) and/or semiconducting material(s) and/or conducting material(s) and/or superconducting material(s).

The BCP-derived material may be ceramic or carbonaceous material. The ceramic or carbonaceous material may be formed by thermal treatment (which may include carbon removal, densification, solid state chemical transformation, (e.g., conversion of an oxide to, for example, a nitride, carbide, or the like), and the like, and any combination thereof) of a self-assembled block copolymer, optionally, in combination with an organic additive (e.g., an additive that forms an inorganic material and/or carbonaceous material on thermal treatment) and/or inorganic additive (e.g., an additive that forms an inorganic material on thermal treatment) or a combination thereof.

The BCP-derived material may be superconducting (e.g., a superconducting ceramic material or the like). Non-limiting examples of superconducting materials include niobium nitrides, niobium carbonitrides, titanium nitrides, titanium carbonitrides and the like.

A BCP-derived material and/or an inorganic material/inorganic materials, organic material/organic materials, or a combination thereof may exhibit disorder. The disorder may be atomic level disorder and/or mesoscale level disorder. By atomic level disorder (which may be referred to as a glass) it is meant that there is no period lattice that can be used to describe the relative positions of atoms. By mesoscale level disorder (which may be referred to as disordered mesostructured), it is meant that there is no underlying lattice that can be used to describe the structure at the mesoscale (e.g., as described by as defined by IUPAC).

As an illustrative example, at least a portion of or all of the BCP-derived material has a locally disordered structure (e.g., a non-crystalline SiCN ceramic or the like) with an ordered gyroidal mesostructure, where the gyroidal lattice is polycrystalline or single crystalline. In this example, at least a portion of or all of the templated material may be atomically amorphous (e.g., a glass or the like) or atomically ordered/crystalline (e.g., polycrystalline or single crystalline).

A nanocomposite material can have various forms and/or sizes. A nanocomposite material may be a three-dimensional object. A nanocomposite material may be monolithic. A monolithic nanocomposite material may be free-standing. In various examples, the BCP-derived material (which may be a BCP-derived template) has a thickness of 20 nm to 5 mm, including all 0.1 nm values and ranges therebetween, and/or a longest linear dimension of up to 30 cm or greater. In various examples, a BCP-derived template has an area of up to 900 square centimeters or greater. Of course, BCP-derived materials having greater thickness and/or longest linear dimensions and/or areas are envisioned.

A nanocomposite material may be a film, which may be disposed on at least a portion of or all of a surface or all of the surfaces of a substrate. The film may be a free-stranding film.

In various examples, at least a portion of or all of a BCP-derived material and/or at least a portion of or all of one or more or all of an inorganic material/inorganic materials, organic material/organic materials, or a combination thereof is/are:
atomically disordered (e.g., a glass or the like) and disordered at the mesoscale,
atomically ordered and disordered at the mesoscale,
atomically disordered and mesoscale ordered,
atomically ordered and mesoscale ordered, or the like, or a combination thereof.
   In these examples, the BCP-derived material has the same mesoscale order as the templated material. In each example, for the atomic level and/or mesoscale level, the order may at least partially or completely polycrystalline (e.g., powder-like order or the like) or at least partially or completely single crystalline.

The nanocomposite and/or the inorganic material(s), organic material(s), or a combination thereof may be a quantum defined material. The nanocomposite and/or the inorganic material(s), organic material(s), or a combination thereof may be a superconducting material. In various examples, the nanocomposite and/or the inorganic material(s), organic material(s), or a combination thereof exhibits an abrupt decrease in resistivity at a critical temperature, magnetic flux exclusion at a critical temperature, or the like, or a combination thereof. The nanocomposite and/or the inorganic material(s), organic material(s), or a combination thereof may exhibit super conducting behavior. Non-limiting examples of superconducting behavior include an increased critical field, an increased critical current, an increased critical temperature, a change in magnetization hysteresis, an increase in magnetic flux pinning, an observed change in characteristic parameters, or the like relative to the bulk material(s) (the bulk the inorganic material(s) and/or organic material(s)).

A nanocomposite material may comprise a plurality of interpenetrating networks (e.g., one or more inorganic material(s), organic material(s), or a combination thereof networks (which individually or taken together may be majority or minority networks (e.g., with regard to the nanocomposite volume) and/or one more BCP-derived material (e.g., ceramic material or the like) network(s) (which individually or taken together are majority or minority networks). In various examples, one or more (or all) of the individual network(s) provide(s) a continuous pathway (e.g., an electrical conduction pathway or the like) throughout the three-dimensional volume of the nanocomposite material.

In various examples, the BCP-derived material has the following structure:
the majority (matrix) volume of the double gyroid structure,
the minority volumes of the double gyroid network structure,
the minority volume (no plural here) of the alternating (or single) gyroid network structure,
the majority (matrix) volume of a hexagonal cylinder structure,
the majority (matrix) volume of the hexagonally perforated lamellar structure,
the majority (matrix) volume of the orthorhombic (O70) network structure,
the minority volume of the orthorhombic (O70) network structure,
the majority (matrix) volume of the double diamond network structure,
the minority volumes of the double diamond network structure,
an L₃ phase (e.g., L₃ a disordered phase or the like), or the like.
   In these examples, the one or more inorganic material(s), one or more organic material(s) or a combination thereof (which may be referred to as backfilled material(s)) occupy (e.g., 60% or more, 70% or more, 80% or more, 90% or more, 95% or more, 98% or more, or 99% or more) of the void spaces of these template structures discussed above (same sequence as above):
the minority volumes (there are two) of the double gyroid structure,
the majority volume of the double gyroid network structure,
the majority volume of the alternating (or single) gyroid network structure,
the minority volume (i.e., the cylinder volume) of a hexagonal cylinder structure,
the minority volume of the hexagonally perforated lamellar structure,
the minority volume of the orthorhombic (O70) network structure,
the majority volume of the orthorhombic (O70) network structure,
the minority volumes of the double diamond network structure, or the like the majority volume of the double diamond network structure, or the like.

In various examples, a nanocomposite further comprises one or more electrically conductive material(s) (e.g., an electrode material, an electrode, or the like) disposed on at least a portion of a surface of the nanocomposite. Nonlimiting examples of electrically conductive materials include graphitic materials, metals, conductive polymers, and the like, and any combination thereof.

In an aspect, the present disclosure provides compositions. In various examples, a composition is made by a method of the present disclosure. In various examples, a composition is not a solid wire. In various examples, a composition is not made by (or using) electrodeposition or electroless deposition. Non-limiting examples of methods of compositions are disclosed herein.

A composition may comprise (or consist essentially of or consist of) one or more three-dimensional inorganic materials(s), one or more organic material(s), or a combination thereof. The one or more three-dimensional inorganic material(s), organic material(s), or a combination thereof may be or be derived from the one or more inorganic material(s), one or more organic material(s) or a combination thereof defining a three-dimensional space of the nanocomposite of the present disclosure. In various examples, the composition (or at least a portion of or all of the inorganic material(s), organic material(s), or a combination thereof) is continuous or co-continuous (e.g., bi-continuous, tri-continuous, or the like).

The three-dimensional inorganic material(s), organic material(s), or combination thereof may define a variety of shapes. The three-dimensional inorganic material(s), organic material(s), or combination thereof may define a three-dimensional space. At least a portion of all of the inorganic material(s), organic material(s), or a combination thereof may be continuous or co-continuous (e.g., bi-continuous, tri-continuous, or the like).

The inorganic material(s), organic material(s), or a combination thereof may be symmetric/isotropic or symmetric/ordered inorganic material(s), organic material(s), or a combination thereof or an asymmetric/disordered inorganic material(s), organic material(s), or a combination thereof. In various examples, the symmetric inorganic material(s), symmetric organic material(s), or a combination thereof comprise a substantially homogeneous or homogeneous pore structure. In various examples, the asymmetric inorganic material(s), symmetric organic material(s), or a combination thereof comprise macropores and micropores and/or a gradient pore structure. The inorganic material(s), organic material(s), or a combination thereof may be an ordered inorganic material(s), organic material(s), or a combination thereof or disordered inorganic material(s), organic material(s), or a combination thereof. In various examples, the ordered inorganic material(s), ordered organic material(s), or a combination thereof exhibit long range order. In various examples, the disordered inorganic material(s), disordered organic material(s), or a combination thereof cannot be described by a lattice. In various examples, the inorganic material(s), organic material(s), or a combination thereof is (or is 60% or more, 70% or more, 80% or more, 90% or more, 95% or more, 98% or more, or 99% or more of) or defines a three-dimensional space corresponding to at least a part of (e.g., 60% or more, 70% or more, 80% or more, 90% or more, 95% or more, 98% or more, or 99% or more) or all of a cubic double gyroid matrix and/or matrix space, a single (alternating) gyroid matrix and/or network space, a hexagonally packed cylinder matrix space, a hexagonally perforated lamellae space, an orthorhombic matrix and/or network space, a double diamond matrix and/or network space, or the like. The three-dimensional inorganic material(s), organic material(s), or combination thereof may be a symmetric/isotropic or symmetric/ordered inorganic material(s), organic material(s), or a combination thereof or an asymmetric/disordered inorganic material(s), organic material(s), or a combination thereof.

A composition can have various forms and/or sizes. A composition may define a three-dimensional space. A composition may be a three-dimensional object. A composition may be monolithic. A monolithic composition may be free-standing. The composition may be a film, which may be disposed on at least a portion of or all of a surface or all of the surfaces of a substrate. The film may be a free-stranding film. In various examples, the composition has a thickness of 20 nm to 5 mm and/or a longest linear dimension of up to 30 cm or greater. In various examples, a BCP-derived template has an area of up to 900 square centimeters or greater. Of course, compositions having greater thickness and/or longest linear dimensions and/or areas are envisioned.

A composition (or the inorganic material(s) and/or organic material(s) or a portion thereof of the composition) may be a quantum confined material or material(s). The composition (or the inorganic material(s) and/or organic material(s) or a portion thereof of the composition) may exhibit superconducting behavior(s). Non-limiting examples of superconducting behavior include an increased critical field, an increased critical current, an increased critical temperature, a change in magnetization hysteresis, an increase in magnetic flux pinning, an observed change in characteristic parameters, and the like, and any combination thereof relative to the bulk material(s) (the bulk the inorganic material(s) and/or organic material(s)).

At least a portion of or all of the inorganic material(s), organic material(s) or a combination thereof may be amorphous (e.g., having at least one amorphous domain). At least a portion of or all of the inorganic material(s), organic material(s) or a combination thereof may be multigranual (e.g., comprise a plurality of grains). The grains individually may be anisotropic or partially oriented. At least a portion of or all of the inorganic material(s), organic material(s) or a combination thereof may be crystalline (e.g., having at least one crystalline domain, polycrystalline, single crystalline, or the like) and at least a portion of or all of the metal(s) may be amorphous (e.g., having at least one amorphous domain).

At least a portion of or all of the inorganic material(s) and/or organic material(s), or combination thereof may be crystalline (e.g., having at least one crystalline domain, polycrystalline, single crystalline, or the like). At least a portion of or all of the inorganic material(s) and/or organic material(s), or combination thereof may be amorphous (e.g., having at least one amorphous domain). At least a portion of or all of the inorganic material(s) and/or organic material(s), or combination thereof may be crystalline (e.g., having at least one crystalline domain, polycrystalline, single crystalline, or the like) and at least a portion of or all of the metal(s) may be amorphous (e.g., having at least one amorphous domain).

A composition can comprise various inorganic materials and organic materials, and combinations thereof. Non-limiting examples of inorganic materials include ceramic materials, amorphous glasses, semiconductor materials, metal(s), metal alloy(s), non-metal inorganic materials, and the like, and any combination thereof. In various examples, a composition comprises insulating material(s) and/or semiconducting material(s) and/or conducting material(s) and/or superconducting material(s). Non-limiting examples of organic materials include polymers, oligomers, and low molar mass (e.g., 500 g/mol or less, 250 g/mol or less, or 100 g/mol or less) organic molecules, and the like, and any combination thereof. Non-limiting examples of semiconductor materials include crystalline inorganic semiconductor materials (such as, for example, Si, Ge, GaAs, and the like, and any combination thereof), amorphous inorganic semiconductor materials (such as, for example, a-In—Ga—Zn—O (or a-IGZO), a-zinc silicate (a-ZSO), and the like, and any combination thereof), semicrystalline organic polymer semiconductor materials (such as, for example, poly-thiophenes, polyanilines and the like), and the like, and any combination thereof.

Non-limiting examples of metals include In, Sn, Al, Pb, Hg (e.g., alpha-Hg, beta-Hg, or the like), Bi, Ga, Cd, Hf, Ir, La (e.g., alpha-La, beta-La, or the like), Li, Mo, Nb, Os, Pa, Re, Rh, Ru, Ta, Tc, Th (e.g., alpha-Th or the like), Ti, Tl, U (e.g., alpha-U, beta-U, or the like), V, W (e.g., alpha-W, beta-W, or the like), Zn, Zr, Au, Ag, Cu, Na, Ni, Fe, Co, and any combination (e.g., an alloy or the like) thereof or compounds (e.g., sulfide, nitride, oxide, or the like) thereof. In various examples, a ceramic material (which may be nano and/or mesostructured) is superconducting at a temperature above about 70 K (e.g., about 60 K to about 100 K). Non-limiting examples of superconducting ceramic materials include copper oxides and cuprates, such as, for example, LaBaCuO, LaSrCuO, YBaₓCu_{y}O_{z} (e.g., YBa₂Cu₃O₇ (YBCO) and the like), BiᵣSrₛCaₜCuᵥO_{w} (e.g., Bi₂Sr₂Ca₂Cu₃O₁₀ (BSCCO) and the like), TlBaCaCuO, HgBaCaCuO, and HgₐTl_{b}Ba_{c}Ca_{d}CuₑO_{f} (e.g., Hg₁₂Tl₃Ba₃₀Ca₃₀Cu₄₅O₁₂₇ and the like), and the like. In various examples, an inorganic material (which may be nano and/or mesostructured) is an iron-based superconducting material and is superconducting at a temperature above about 70 K (e.g., about 60 K to about 100 K). Non-limiting examples of iron-based superconducting materials include LaOFFeAs, SrFFeAs, FeSe, and the like. In various examples, an inorganic material (which may be nano and/or mesostructured) is a magnesium-based superconducting material and is superconducting at a temperature above about 70 K (e.g., about 60 K to about 100 K). Non-limiting examples of magnesium-based superconducting materials include magnesium diboride (MgB₂) and the like. An inorganic material may be a superconducting material. In various examples, an inorganic material is superconducting at a temperature above about 70 K (e.g., about 60 K to about 100 K). In various examples, a metal or metal alloy (which may be nano and/or mesostructured) is superconducting at a temperature above about 70 K (e.g., about 60 K to about 100 K). Non-limiting examples of superconducting metals and metal alloys include Al, Ga, Pb, Nb, Nb₃Sn, NbTi, Nb₃Ge, and the like.

At least a portion of or all of the inorganic material(s) and/or organic material(s) of the composition may be crystalline (e.g., having at least one crystalline domain, polycrystalline, single crystalline, or the like). At least a portion of or all of the inorganic material(s) and/or organic material(s) of the composition may be amorphous (e.g., having at least one amorphous domain). At least a portion of or all of the inorganic material(s) and/or organic material(s) of the composition may be multigranual. The grains individually may be anisotropic or partially oriented. At least a portion of or all of the inorganic material(s) and/or organic material(s) of the composition may be crystalline (e.g., having at least one crystalline domain, polycrystalline, single crystalline, or the like) and at least a portion of or all of the metal(s) may be amorphous (e.g., having at least one amorphous domain).A composition may comprise a plurality of interpenetrating networks (e.g., one or more inorganic material(s), organic material(s), or a combination thereof networks. In various examples, one or more (or all) of the individual network(s) provide(s) a continuous pathway (e.g., an electrical conduction pathway or the like) throughout the three-dimensional volume of the composition.

In various examples, the one or more inorganic material(s), one or more organic material(s) or a combination thereof occupy (e.g., 60% or more, 70% or more, 80% or more, 90% or more, 95% or more, 98% or more, or 99% or more) of:
a double gyroid structure (which may be minority volumes (e.g., two minority volumes) thereof),
a double gyroid network structure (which may be a majority volume thereof),
alternating (or single) gyroid network structure (which may be a majority volume thereof),
a hexagonal cylinder structure (which may be a minority volume (e.g., cylinder volume) thereof),
a hexagonally perforated lamellar structure (which may be a minority volume thereof),
an orthorhombic (O70) network structure (which may be a minority volume thereof),
an orthorhombic (O70) network structure (which may be a majority volume thereof),
a double diamond network structure (which may be minority volume(s) thereof),
a double diamond network structure (which may be a majority volume thereof),
an L₃ phase (e.g., L₃ a disordered phase or the like), or the like.

In various examples, a composition further comprises one or more electrically conductive material(s) (e.g., an electrode material, an electrode, or the like) disposed on at least a portion of a surface of the composition. Nonlimiting examples of electrically conductive materials include graphitic materials, metals, conductive polymers, and the like, and any combination thereof

In an aspect, the present disclosure provides uses of nanocomposites and/or compositions of the present disclosure. The nanocomposites and/or compositions may be nanocomposites and/or compositions of the present disclosure. In various examples, a nanocomposite/nanocomposites and/or a composition/compositions is integrated in a device. Non-limiting examples of uses of nanocomposites and/or compositions are described herein.

A device may comprise one or more nanocomposite(s) and/or composition(s) of the present disclosure. In various examples, the nanocomposite(s) and/or composition(s) are in electrical contact with a device (e.g., a via one or more electrode materials(s), one or more electrode(s), or the like). Non-limiting examples of devices include electronic devices, energy devices, sensors, and the like. Non-limiting examples of devices include superconducting quantum interference devices (SQUIDs), superconducting qubits, superconducting single photon detectors (SSPDs), microwave kinetic inductance detectors (MKIDs), superconducting microresonators, superconducting amplifiers, and the like. In an example, an electronic device is a Josephson junction or the like. In the case of a device comprising two or more nanocomposite(s) and/or two or more composition(s) may be different (e.g., in terms of one or more compositional feature(s) and/or one or more structural feature(s)) than the other nanocomposite(s) and/or composition(s) (e.g., one or more or all of the nanocomposite(s) and/or one or more or all of the composition(s)).

The following Statements describe various examples of methods, nanocomposites, and compositions of the present disclosure and are not intended to be in any way limiting: Statement 1. A method of making a templated material comprising contacting one or more inorganic material(s) and/or one or more organic material(s), or a combination thereof (which may be in the form of a melt or the like) with a block copolymer (BCP)-derived template defining a three-dimensional space (which may be referred to as a void space) (at least a portion of or all of which may be continuous or co-continuous), where the one or more or more inorganic material(s) and/or one or more organic material(s), or a combination thereof is under pressure (e.g., a pressure greater than ambient pressure), and one or more inorganic material(s) and/or one or more organic material(s) at least partially, substantially, or completely fills (e.g., occupies, infiltrates, or the like) the three-dimensional space (which may be referred to as a templated space) forming a templated material (which taken with the BCP-derived template forms product (which may be a nanocomposite material). Statement 2. A method according to claim 1, wherein the inorganic material(s) (e.g., templated inorganic material(s)) are chosen from ceramic materials, amorphous glasses, semiconductor materials, metal(s), metal alloy(s), non-metal inorganic materials, and the like, and any combination thereof and/or the organic material(s) (e.g., templated inorganic material(s)) are chosen from polymers, oligomers, and low molar mass (e.g., 500 g/mol or less, 250 g/mol or less, or 100 g/mol or less) organic molecules, and any combination thereof. Statement 3. A method according to claim 1 or 2, wherein the pressure is from 1 atm to 10⁴ atm, including all 0.1 atm values and ranges thereof. Statement 4. A method according to any one of the preceding claims, the method further comprising removing at least a portion, substantially all, or all of the BCP-derived template. Statement 5. A method according to any one of the preceding claims, the method further comprising annealing the BCP-derived template and templated material (e.g., the nanocomposite) or the templated material before or after removal of at least a portion, substantially all, or all of the BCP-derived template. Statement 6. A nanocomposite material comprising one or more inorganic material(s), one or more organic material(s) or a combination thereof defining a three-dimensional space and a BCP-derived material (which may be a BCP-derived template material), wherein the BCP-derived material is disposed on at least at a portion of or substantially all of a surface or surfaces of the inorganic material(s), organic material(s), or a combination thereof. The nanocomposite material may be made by a method of the present disclosure (e.g., a method of any one of claims 1-5).

Statement 7. A composition comprising (or consisting essentially of or consisting of) one or more three-dimensional inorganic materials(s), one or more organic material(s), or a combination thereof. The composition may be made by a method of the present disclosure (e.g., a method of any one of claims 1-5). The one or more three-dimensional inorganic material(s), organic material(s), or a combination thereof may be or be derived from the one or more inorganic material(s), one or more organic material(s) or a combination thereof defining a three-dimensional space of the nanocomposite of claim 6.

The steps of the method described in the various examples disclosed herein are sufficient to carry out the methods of the present disclosure. Thus, in an example, a method consists essentially of a combination of the steps of the methods disclosed herein. In another example, a method consists of such steps.

The following example is presented to illustrate the present disclosure. The example is not intended to be limiting in any manner.

### EXAMPLE

The following is an example of templated materials, methods of making same, and methods of using same.

Mesoscale order can lead to emergent properties including phononic bandgaps or topologically protected states. Block-copolymers offer a route to mesoscale periodic architectures, but their use as structure directing agents for metallic materials has not been fully realized. A versatile approach is demonstrated to mesostructured metals via bulk block-copolymer self-assembly derived ceramic templates. Molten indium is infiltrated into mesoporous, double gyroidal silicon nitride templates under high pressure to yield bulk, three-dimensionally (3D) periodic nanocomposites as free-standing monoliths which exhibit emergent quantum-scale phenomena. Vortices are artificially introduced when double gyroidal indium metal behaves as a type II superconductor, with evidence of strong pinning centers arrayed on the order of the double gyroid lattice size. Sample behavior is reproducible over months, showing high stability. High pressure infiltration of bulk block-copolymer self-assembly based ceramic templates is an enabling tool for studying high-quality metals with previously inaccessible architectures, and paves the way for the emerging field of block-copolymer derived quantum metamaterials.

In this work is demonstrated a robust, versatile route to mesostructured metal superconductors using high pressure melt infiltration of liquid indium metal into bulk BCP self-assembly—derived mesoporous double gyroid ceramic templates. The combination of an exclusively physical process of infiltration with an extremely resilient ceramic template is expected to be broadly transferrable to many materials. As such, this method represents a fundamental and broad advance in the synthesis of high-quality bulk mesostructured metals from BCP structure directed porous templates, and is an enabling step for the full realization and fundamental understanding of self-assembly derived metamaterials.

To date the only existing route to a mesostructured superconductor with bulk block copolymer self-assembly derived 3D periodic network structure, which allows facile tuning of both morphology and lattice parameters, is via bulk BCP-inorganic hybrid self-assembly into a single (alternating) gyroid (only one of the two gyroid minority networks is constituted by the superconducting material). This method requires multiple processing steps, however, to convert mesostructured niobia into niobium nitride and other refractory ceramics. Such an approach inherently convolutes material chemistry and mesostructure formation due to the sensitivity of high-temperature solid-state reactions to surface area or chemistry and the wide array of possible substituents. Thus, the direct comparison of various morphologies or lattice parameters may not be easily possible. Similarly challenging is the comparison of such materials to their corresponding bulk equivalents, making it difficult to parse the effects of mesostructure and chemistry on the final superconductor properties.

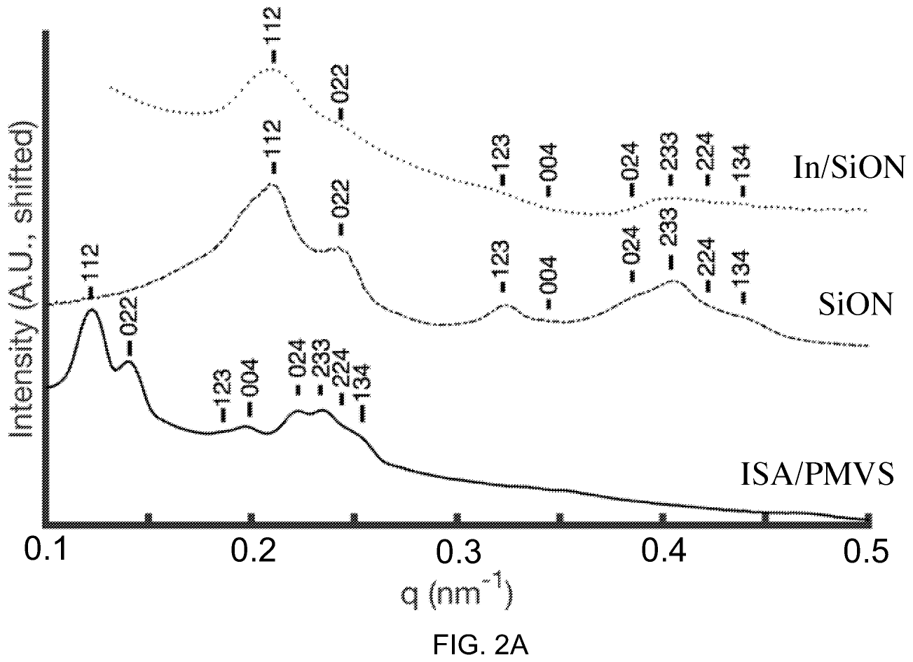

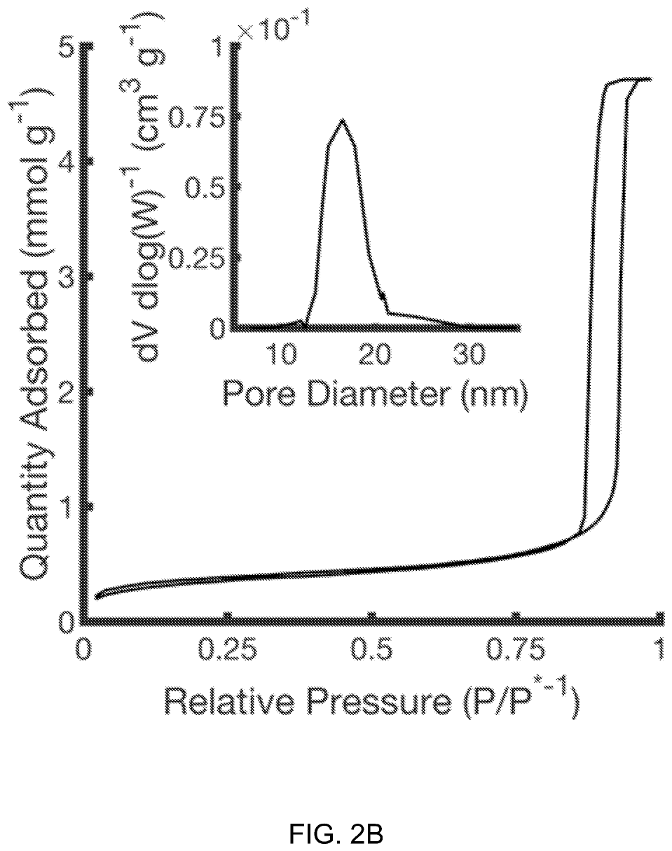

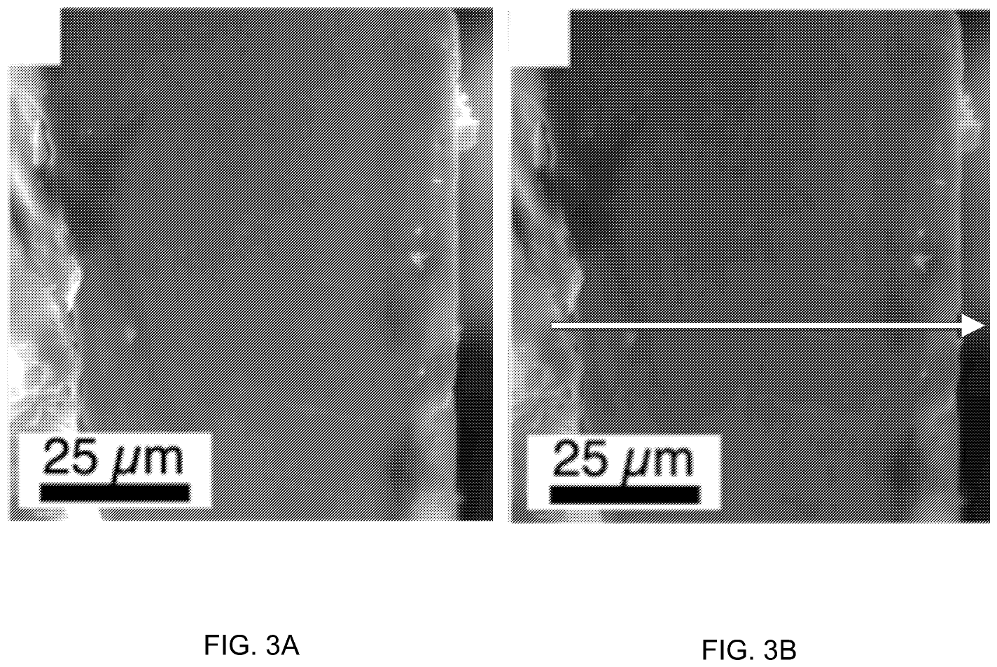

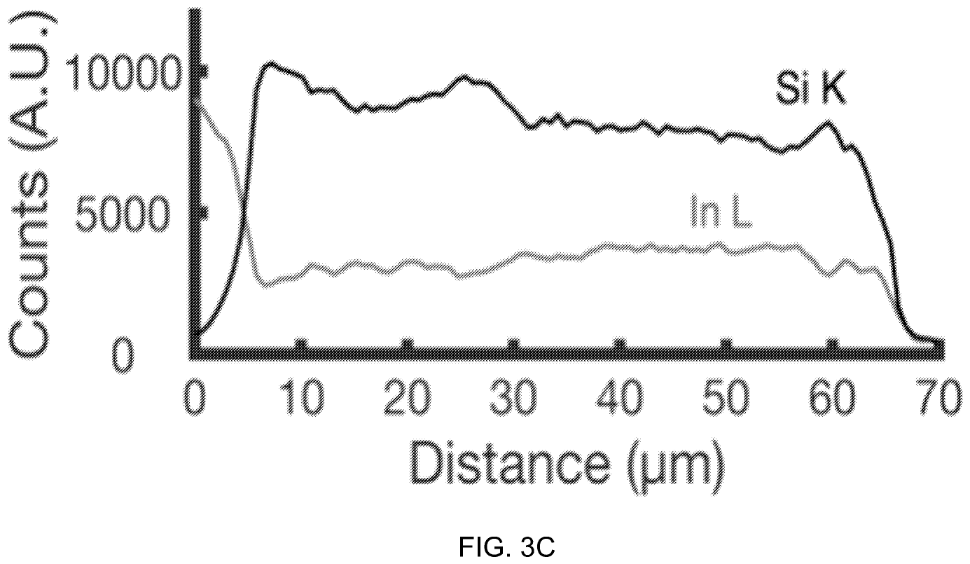

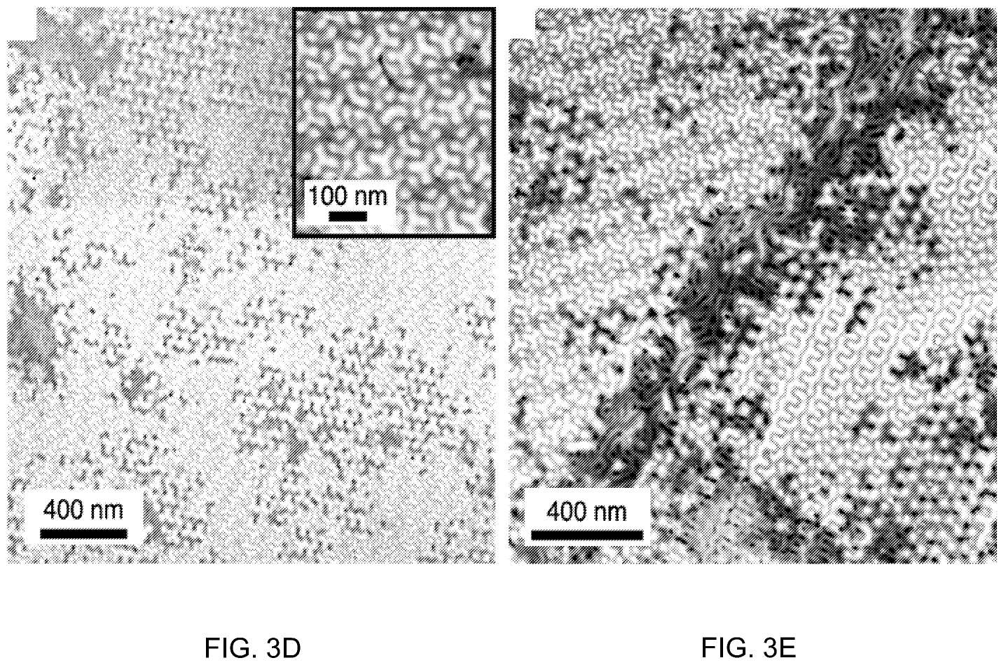

Materials Synthesis and Structural Characterization. A platform based upon pure metals solves these issues, yielding compositionally simple and stable materials for the direct investigation of the effects of mesostructure on superconductivity. To that end, in this work high pressure infiltration of molten indium into a porous silicon oxynitride (SiON) ceramic was used to create novel bulk nanocomposites with double gyroid morphology (FIG. 1A). In a method previously reported, a poly(isoprene-b-styrene-b-dimethylamino-ethylmethacrylate) (PI-b-PS-b-PDMAEMA, or simply ISA) triblock terpolymer with overall molar mass of 79 kDa, polydispersity of 1.09 and with I, S, and A block volume fractions of about 20%, 30%, and 50%, respectively, is used to structure direct poly(methyl vinyl silazane) (PMVS) into a hybrid material with double gyroid structure via evaporation induced self-assembly (EISA). The nanostructured bulk ISA/PMVS composite monolith is then converted via thermal processing into a mesoporous SiON ceramic, which serves as a mechanically strong and chemically resistant template for the infiltration of molten metal (FIG. 1A). After EISA, the hybrid BCP/polysilazane composite monolith (FIG. 2A, solid trace) exhibits x-ray diffraction peaks characteristic of a double gyroid with a d100 of 125 nm. This structure is retained after pyrolysis in ammonia to 1000 ° C. despite isotropically shrinking to a d100 spacing of 73 nm (FIG. 2A, dashed trace) in the SiON material. In nitrogen sorption/desorption measurements the resulting ceramics show a type IV-Hi hysteresis (FIG. 2B) as expected for well-ordered mesoporous materials and consistent with earlier studies. The Brunauer-Emmett-Teller (BET) derived surface area of a representative sample is 21 m 2 /g, with a narrow Barrett-Joyner-Halenda (BJH) pore size distribution centered around 18 nm (FIG. 2B, inset). After infiltration of the two interpenetrating minority network void spaces of the mesoporous ceramic with molten indium (FIG. 1B, shaded volume), the domain spacing is unchanged while higher order reflections appear to decrease in intensity (FIG. 2A, dotted trace). The absence of these higher order peaks may be due to disorder in the lattice or to measurement differences: SAXS data for the ISA/PMVS and ceramic monoliths were obtained at synchrotron sources, while SAXS data for the indium infiltrated sample was obtained using a rotating anode lab source. Retention of the peaks characteristic of the double gyroid space group in the top trace, the absence of any additional or forbidden reflections as a result e.g. of lattice distortions, and scanning electron microscopy (SEM) analysis shown in FIG. 3A however all suggest that the mesostructure is largely undisturbed by the metal infiltration.

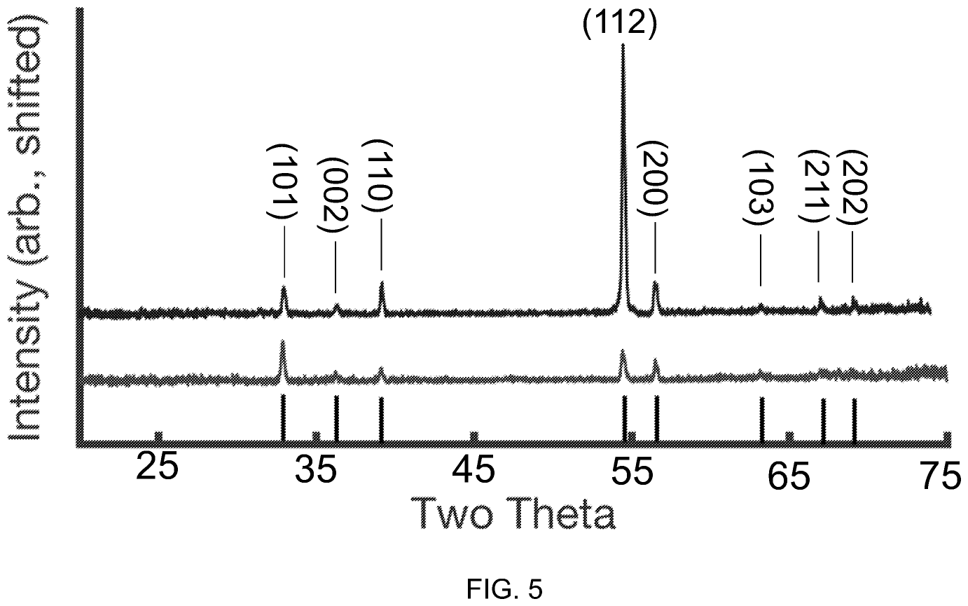

Infiltration of the free-standing, monolithic SiON template is accomplished by heating the ceramic and metal together under vacuum above the melting point of indium before applying a large isostatic pressure of up to 400 MPa of helium. The pressure required for infiltration of the porous material is approximated by the Young-Laplace equation. It was observed that no infiltration of indium occurred using pressures up to 7 MPa, likely a result of the high surface energy of the liquid metal and its large contact angle with the SiON. After isostatic pressure is used to force the liquid metal into the network channels of the template, the system is cooled and depressurized, trapping solidified indium in the pores of the monolith. In the resulting gyroidal In/SiON composite, indium fills the voided double minority network phase within a SiON majority double gyroid matrix. X-ray diffraction (XRD) traces for indium metal used in the infiltration and indium metal/ceramic composite after infiltration are shown in FIG. 5.

The extent of indium infiltration is visualized via energy dispersive x-ray spectroscopy (EDX; FIG. 3B). The homogenous distribution across the sample (FIG. 3A) suggested by the elemental map (FIG. 3B) is corroborated by the characteristic x-ray emission for indium and silicon across the width of the monolith shown in FIG. 3C. Aside from residual bulk indium depicted at the left surface of the monolith (later removed by chemical etching and polishing prior to magnetic measurements), the distribution of indium (from the backfilled network) as compared to silicon (from the ceramic matrix) is relatively constant throughout the composite. These results suggest homogeneous backfilling throughout the more than 50 micron thick freestanding sample, demonstrating that high pressure melt infiltration of BCP based mesoporous templates is a viable approach to bulk mesostructured metals.

Backscattered electron micrographs make use of the high atomic weight (high Z) contrast present between the SiON matrix and indium network phases to highlight the mesoscale structure: bright areas of the images in FIG. 3D correspond to the high Z indium while darker areas correspond to the lower Z ceramic. While these two images corroborate successful overall backfilling with indium, the micrograph in FIG. 3E highlights those areas with incomplete filling of the template remain. These are often associated with the boundaries of two mesoscopic double gyroid grains at different orientations (shown here along the bottom left to upper right diagonal). It appears that along the grain boundary, indium fills only a small fraction of the SiON template void fraction. From EDX analysis showing macroscopically homogenous indium infiltration and SEM micrographs of individual grains, it is hypothesized that this is due to mesostructural heterogeneity as opposed to inconsistency in backfilling. During infiltration, indium metal fills the continuous networked porous volume, leaving empty the isolated and inaccessible voids at, e.g., grain boundaries. This is supported by recent large volume electron microscopy reconstructions of BCP double gyroids showing the presence of network breaking defects that would impede backfilling of the voided channels.

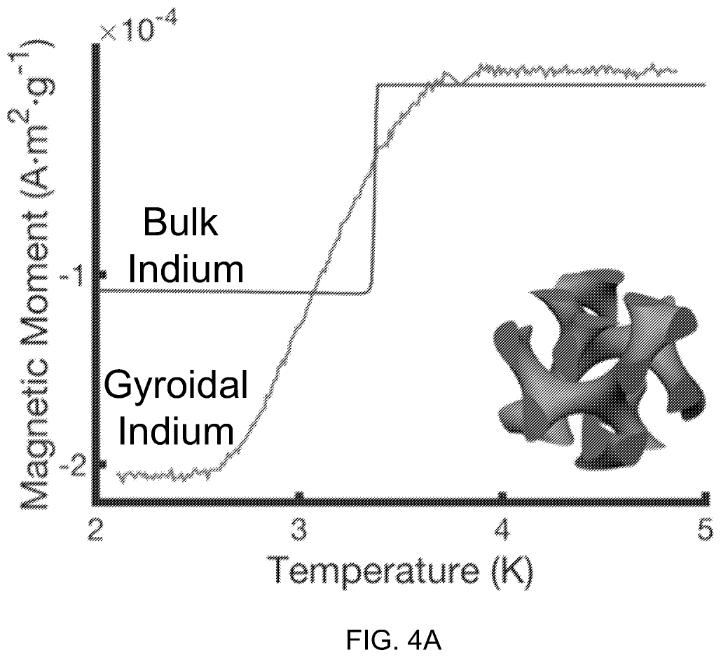

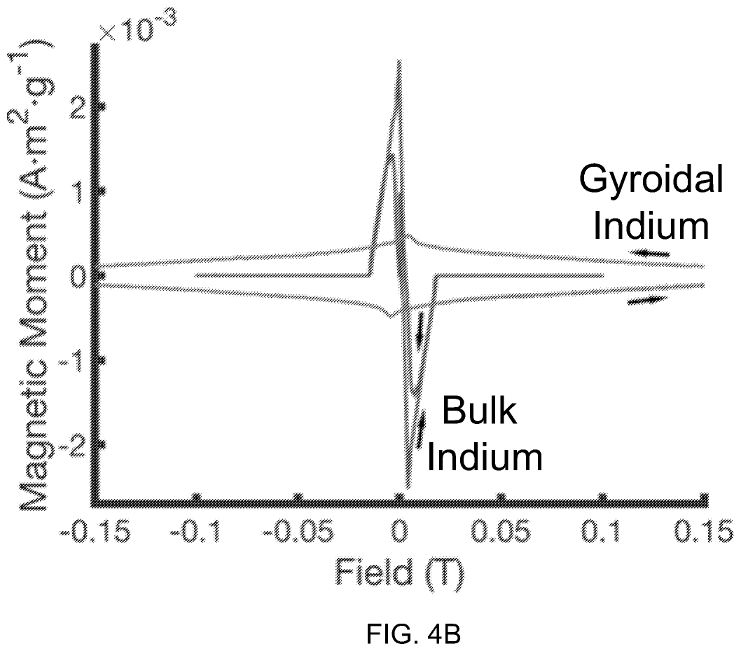

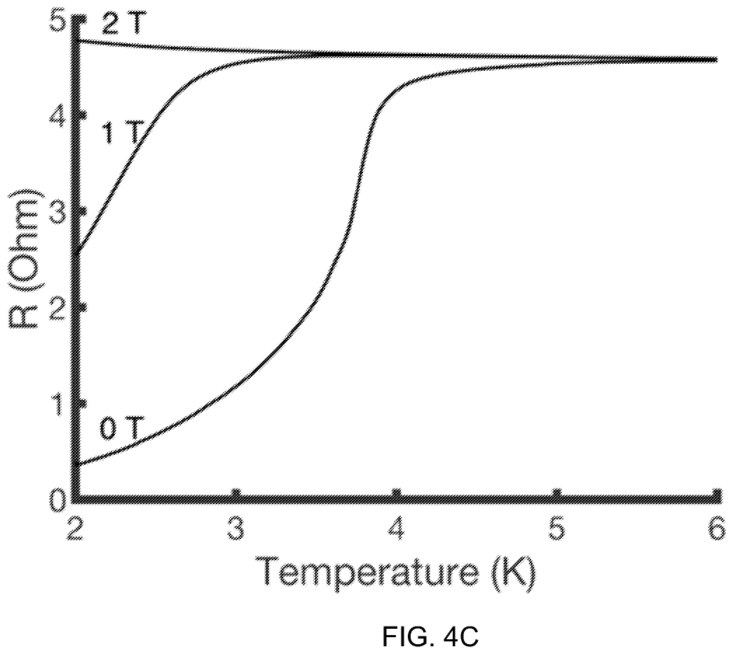

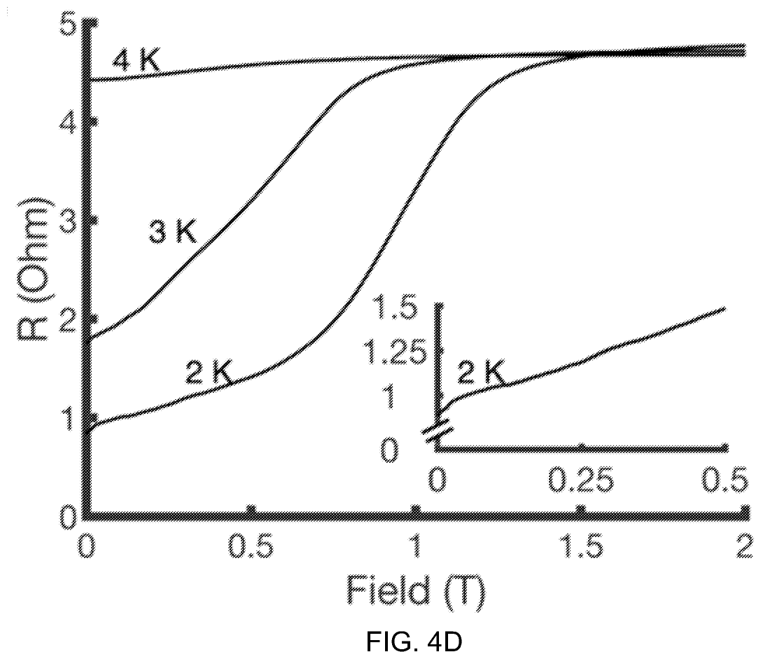

Gyroidal In/SiON Nanocomposites in the Superconducting State. Superconducting properties of the indium/SiON composite, as revealed by vibrating sample magnetometry (VSM) and four-point DC transport measurements, are depicted in FIGS. 4A-4D. For comparison, pure indium was cut from the same batch used for the infiltration and flattened into a 100 μm foil, on the same order of thickness as the 63 μm thick composite monolith. Comparison of the behavior (FIG. 4A) of mesostructured indium to its bulk equivalent reveals substantial differences, including distinctly different behavior around the transition temperature (T_{c}). Pure indium exhibits a narrow transition at≈3.4 K, consistent with literature reports. The polished mesoscopic sample, in contrast, exhibits a much broader transition. Superconducting behavior is observed at a high temperature ‘onset’ of 3.7 K, while the transition midpoint is depressed to ca. 3.1 K.

The increase in the T_{c} onset is compelling evidence that the mesoscale structure of the indium is dictating electronic behavior, agreeing with predictions and measurements in indium nanoparticles or thin films. This effect may be explained as a result of lower frequency surface phonon modes, which reduce the average phonon frequency in a confined system, so called “phonon-softening”. The simultaneous broadening of the transition is also likely a consequence of the mesoscale confinement of indium in the two void networks of the SiON template. Residual strain from the high pressure infiltration is likely contributing, but cannot fully explain the behavior observed; indium metal under 200 MPa of pressure experiences a decrease in T_{c} of less than 0.1 K. Similar phenomena have been observed in isolated superconducting wires, where the broadening of resistive transitions can be attributed the generation of quantum phase slips. Furthermore, in isolated nanoparticle systems, reduction in particle size below 20 nm leads to the so-called quantum size effect (QSE) from the discretization of electronic bands. The QSE opposes phonon softening in superconductors, lowering the Tc compared to the bulk value. The counterbalancing nature of these effects in mesoscopic superconductors presents an interesting opportunity for interconnected architectures such as the double gyroid: the networked structure could take advantage of the T_{c} boosting effects of phonon softening while avoiding T_{c} depression from quantum confinement. At the same time, the exquisite control afforded by BCP self-assembly may allow for topological engineering of the QSE for additional improvement of T_{c} through exploitation of effects such as the coherent shell effect.

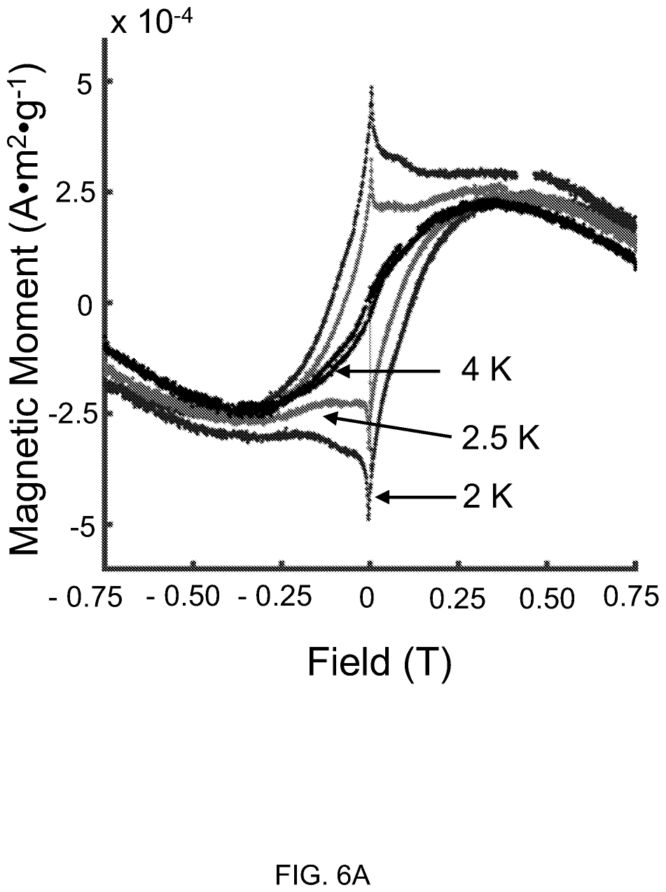

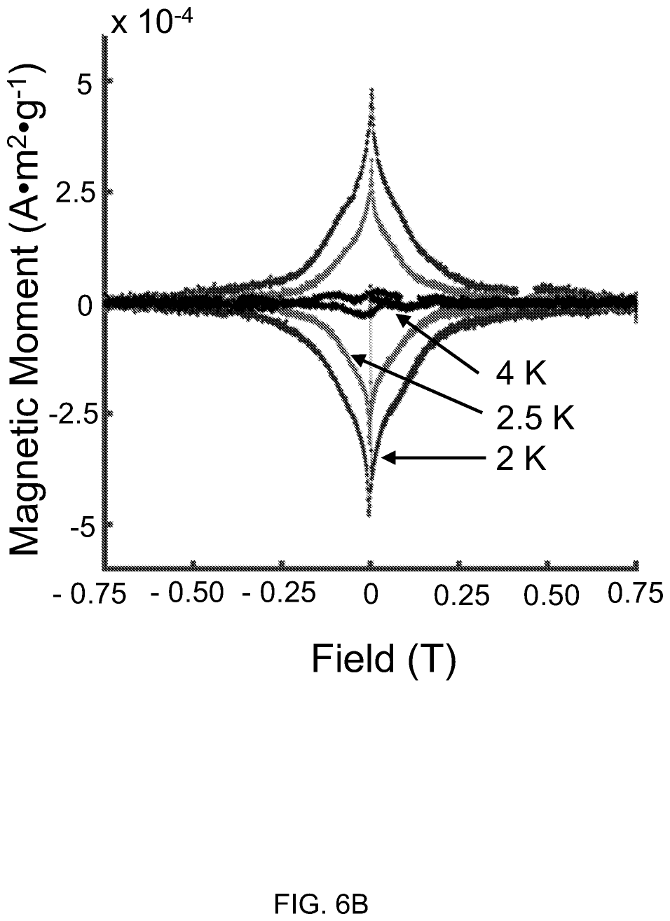

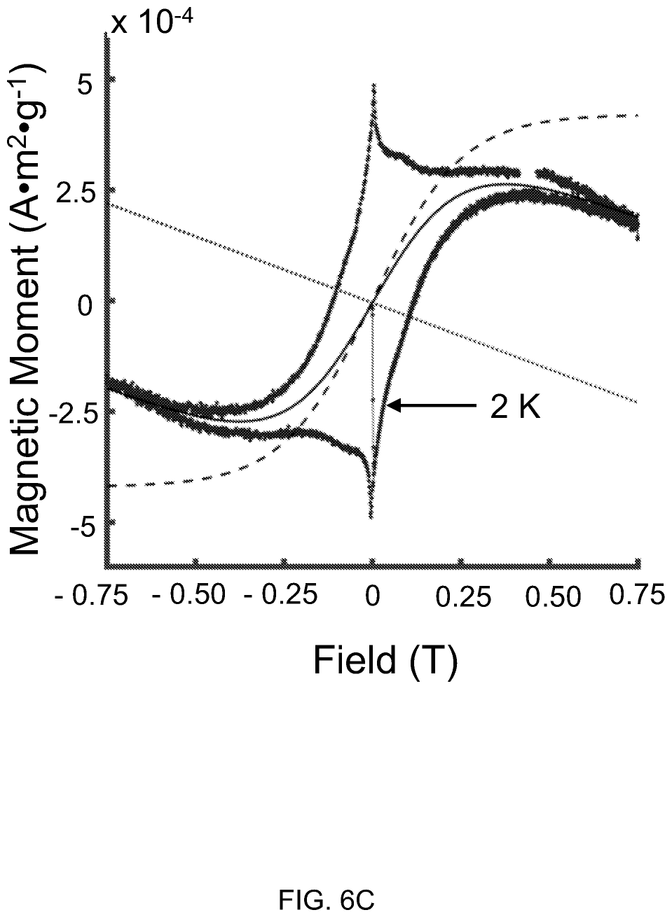

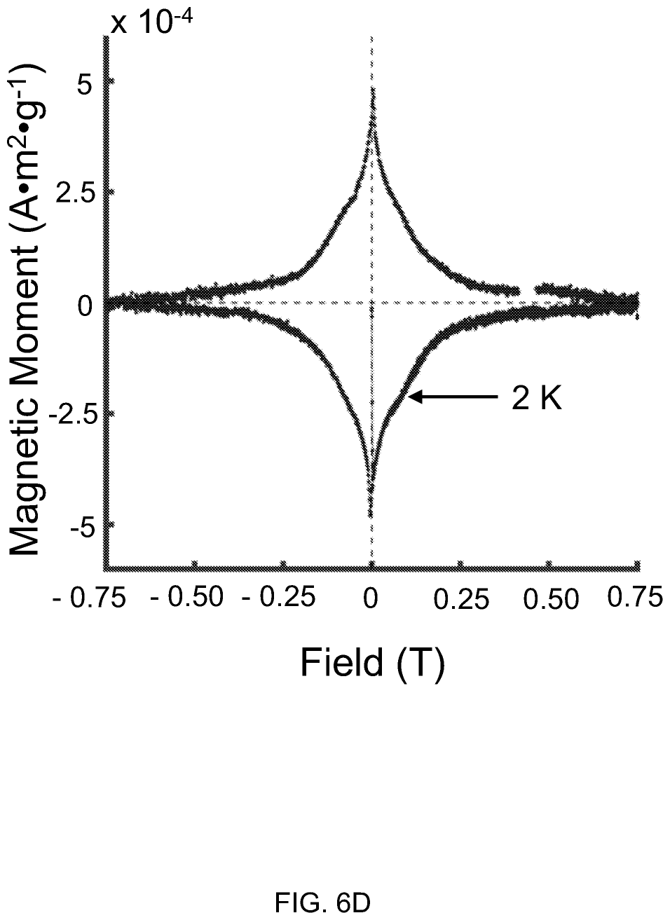

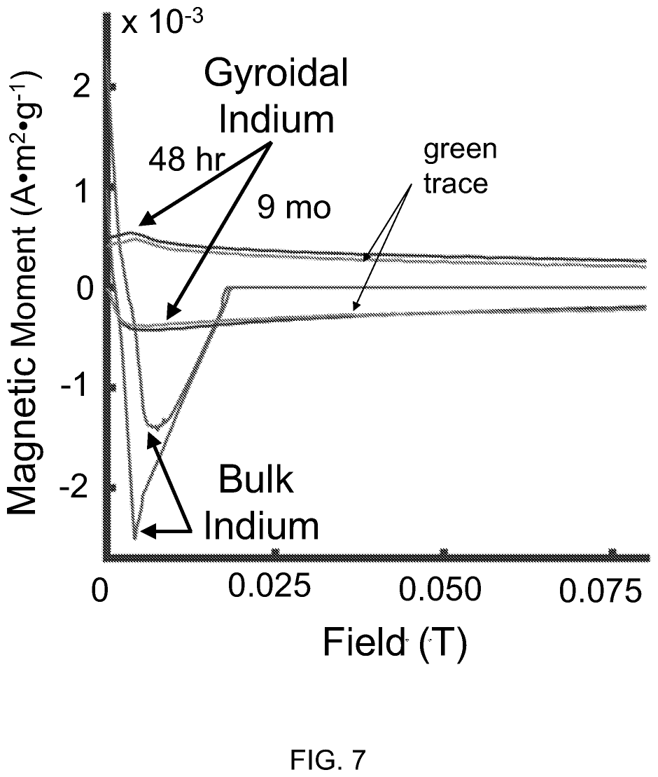

The magnetization behavior of the In/SiON composite also differs substantially from that of the pure metal (FIG. 4B). The 100 μm thick pure indium foil (red trace) behaves as a characteristic type-I superconductor, with an initial linear decrease in magnetic moment up to 3.8 mT. Near≈3.8 mT the pure indium appears to transition into an intermediate state, increasing in susceptibility until fully entering a normal state above the critical field of μₒH_{c}≈23 mT. This behavior is consistent with reports of superconductivity in indium films. The magnetization curve of the pure indium foil exhibits some hysteresis upon scanning the field in the field lowering direction due to demagnetization, similar to the “topological” hysteresis seen in the intermediate type I state of lead foils of similar thickness. In sharp contrast, the indium confined to the 63 μm thick double gyroidal composite monolith exhibits emergent behavior characteristic of hard type II superconductors. The slope of the magnetization in the initial linear regime at low fields gives a magnetic susceptibility of≈−0.8, assuming an average density of≈5 g cm⁻³ for the SiON/In composite. While this does not account for demagnetization in the irregular platelet-like sample, this entails that some flux penetration occurs even below H_{c1}. Upon raising the external field significant hysteresis is observed, with the lower critical field (H_{c1}) depressed below the bulk to μₒH_{c}=2.5 mT, while the upper critical field (at which magnetization completely disappears) increases to≈0.63 T (FIGS. 6A-6D). This upper critical field matches the characteristic field for overlapping vortices on a triangular lattice of 62 nm, comparable to the double gyroid unit cell size of 73 nm. Further, the irreversibility of the magnetization curve implies the introduction of strong pinning centers in the In/SiON composite. It is notable that this emergent magnetization behavior of double gyroidal indium is reproducible even after several months of storage under ambient conditions (FIG. 7) suggesting high sample stability. While point defects (such as chemical impurities or vacancies) can serve as pinning sites, the chemically inert melt infiltration and absence of such strong pinning centers in the bulk sample suggests that the origin of the pinning is likely the mesostructure. This is corroborated by work performed on inverse opal templated metals, where evidence suggests vortex pinning commensurate with the opal lattice size. However, in contrast to the inverse opal type structures, which consist of large nodes connected by an order of magnitude smaller in diameter ‘weak links’, the gyroid structures present in this work consist of networked struts of relatively homogeneous diameter throughout. This distinction is important for consideration of the origin of flux pinning as well other properties which arise due to confinement, as explored in the next section.

Transport behavior of the confined indium metal roughly matches the behavior observed in the magnetization measurements. A distinct transition to a superconducting state at≈3.5 K in zero external field is displayed in FIG. 4C, with similar broadening observed. Just above the onset temperature of 3.7 K exhibited in the magnetization measurements, a distinct slope change is seen with deviations from the normal resistance up to 6 K. This excess conductivity in the normal state just above the critical temperature is often observed in systems with reduced dimensionality, where fluctuations are expected to have a much greater relative effect. In FIG. 4D, distinct transitions appear at field strengths matching the critical fields as seen in FIG. 4B and FIG. 6. At the observed lower critical field of≈2.5 mT, a change in slope can be noticed for the sample measured at 2 K. Starting at≈0.63 T, another transition can be seen matching the upper critical field. Here too it is observed that the transition is relatively broad, with deviations from the normal state resistance occurring up to much higher fields than in the magnetization measurements. This could be indicative of longer lived surface superconductivity in the double gyroidal material, which would contribute much less to the bulk magnetization.

Important to this consideration is the presence of the dielectric SiON ceramic matrix forming an interface with the indium throughout the composite. It is known that at the interface of metal and insulator, superconductivity can nucleate at surfaces parallel to the external field up to a critical field H_{c3} higher than the upper critical field H_{c2} by almost a factor of two. This would correspond to surface nucleation up to an external field of≈1.3 T in the case of the In/SiON, which roughly matches the slope change above 1 T seen in FIG. 4D. The 3D networked double gyroidal indium studied here has a very large relative surface area. Therefore, non-negligible contributions of surface superconductivity from indium/SiON interfaces oriented parallel to the external field to the transport can be expected. The presence of the ceramic SiON matrix/separator (as opposed to e.g., air) in the composite could be important for surface plasmons confined to the dielectric/metal interface or Josephson coupling of neighboring superconductor wire networks, though it should be noted that the ≈20 nm thickness of the SiON interlayer in this work likely precludes significant tunneling current. However, as previously mentioned, a particular strength of BCP self-assembly is the ability to tune the lattice parameter of mesoscopic architectures while maintaining material symmetry. Theoretically this could enable decreasing the SiON dielectric matrix thickness below a threshold to achieve high tunneling currents and Josephson coupling between the distinct, interpenetrating left- and right-handed chiral networks of the double gyroid.

The residual resistance observed in FIGS. 4D-4E could also be a result of inhomogeneity in the double gyroidal indium network itself. As shown in FIG. 3E, mesoscale grain boundaries in the mesoscale polycrystalline double gyroidal template can prevent complete filling of the void space. At such boundaries, only a few isolated indium pathways connect more completely filled double gyroid grains. These ≈18 nm diameter isolated wires could account for the incomplete flux exclusion observed below H_{c1}, and may be prone to thermally activated phase slips below the critical temperature. This has been observed to yield a finite resistance in type I superconductor nanowires.

The Effect of Mesostructure on Superconducting Properties. The overall shift from type-I to type-II behavior is consistent with the observed change in the underlying material properties and length scales. The Ginzburg-Landau-Abrikosov-Gor'kov (GLAG) theory of superconductors classifies superconductor type in terms of the energy of the superconductor-normal interface, which in turn is determined by the Cooper pair coherence length, ξ₀, and London penetration depth, λ_{L}. The ratio between these two characteristic lengths, termed the Ginzburg-Landau (GL) parameter, κ, defines the point at which a material switches from type Ito type II behavior as I/\sqrt{2}. This parameter is highly dependent on the mean free electron path, which can be substantially reduced in granular or “dirty” superconductors. The reduction in mean free electron path has been observed to result in type I to type II transitions in many metals in thin film and nanoscale geometries, including inverse opal lattices. In indium thin films, however, the transition from type I intermediate structures to vortex formation at high field strength does not occur until films become thinner than 80 nm. In the case of the 63 μm thick composite In/SiON double gyroid reported here, it is therefore the mesoscale periodic structure of the indium metal which is likely dictating the material properties. This can be further demonstrated by an estimation of the effective characteristic lengths in the double gyroidal indium via Equation (1).

$${H}_{c 2} = \frac{{Φ}_{o}}{2 {πμ}_{o} {ξ}^{2}} \qquad ( 1 )$$

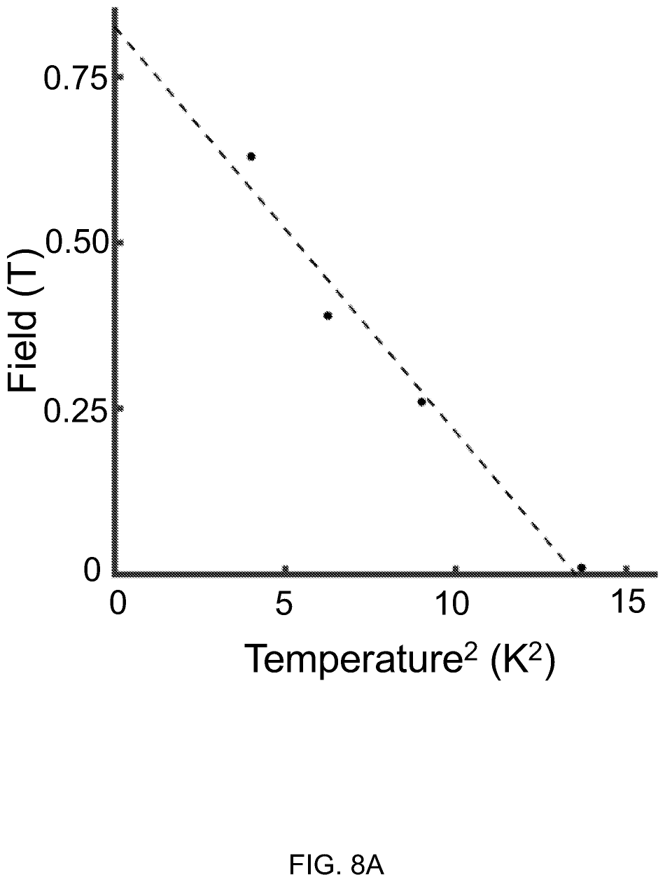

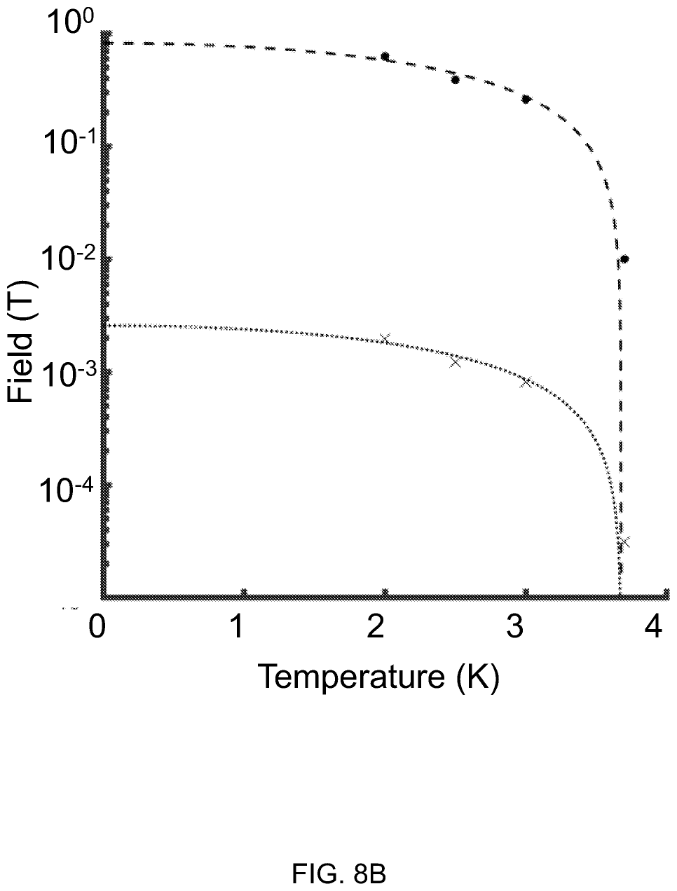

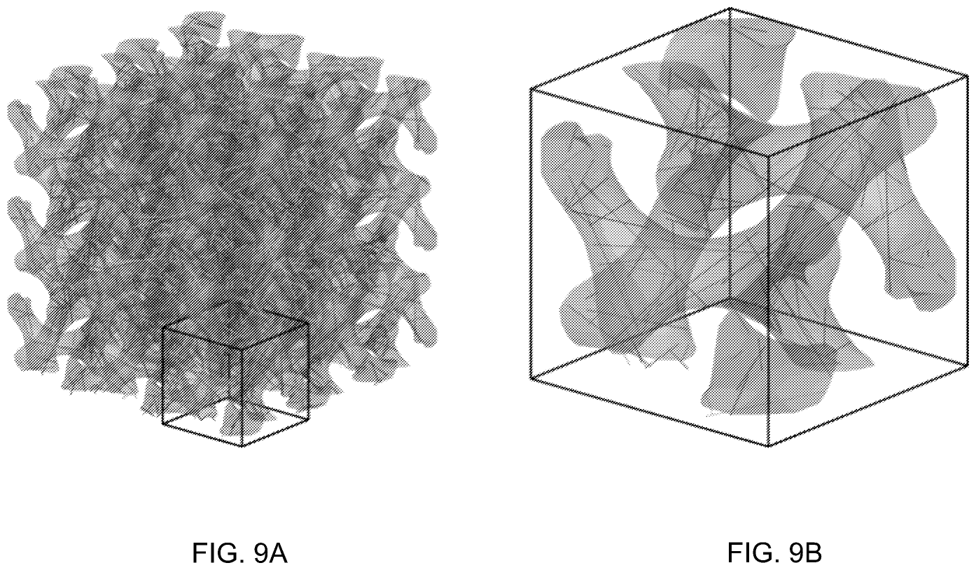

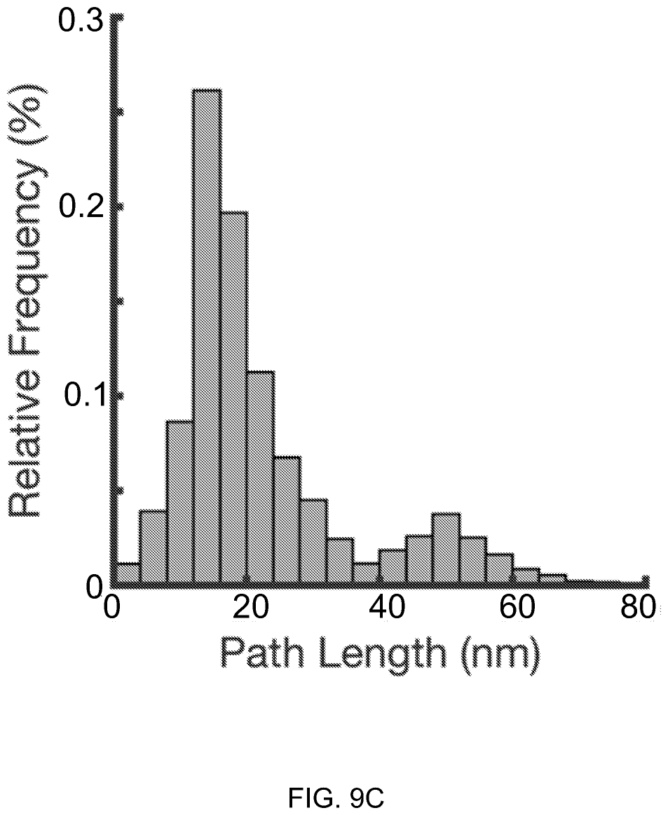

In this relationship, derived by GLAG theory, H_{c2} corresponds to the upper critical field at 0 K, ξ to the effective coherence length at 0 K, and φₒ to the magnetic flux quantum. Observation of the upper critical field of the double gyroidal indium at varying temperature (FIGS. 6A-6D) and a fit to the GL relation H_{c2}(T)=H_{c2}(0)·(1−(T/T_{c})² (FIGS. 9A-9C) gives the values for H_{c2}(0), and ξ, and T_{c} shown in Table 1. The effective London penetration depth can then be estimated from the effective coherence length using the dirty limit expressions ξ=0.865(ξₒl_{eff})^{1/2}, and λ=0.66 λ_{L} (ξₒL_{eff})^{1/2}, where ξₒ and λ_{L} are taken as the bulk values of indium and / is the effective electron mean free path. While simplistic, this treatment matches the critical temperature as detected in FIG. 4A and the observed lower critical fields reasonably well (FIG. 8B).

TABLE 1

| | T_{c} (K) | μ₀H₀ (T) | ξ (nm) | λ_{L} (nm) | κ |
|---|---|---|---|---|---|
| Bulk | 3.37^{†} | 2.8 × 10^{-2†} | 360* | 65* | 0.18 |
| Double | 3.67 | 0.83 | 20 | 670 | 33.5 |
| Gyroid | | | | | |

Critical values and characteristic lengths for bulk indium metal as compared to parameters calculated for the mesostructured indium in the double gyroidal metal/ceramic composite.
^{†}Critical temperature and field for bulk indium previously reported.
*Characteristic lengths for bulk indium previously reported.

From Table 1 it is apparent that the GL parameter, κ, and thus the superconductor type, changes drastically in the mesostructured indium relative to the bulk. Notably, the estimated coherence length in the double gyroidal metal network, ξ=20 nm, is on the same order as the BJH derived pore size, 18 nm (FIG. 2B), and the average ballistic path within the confines of a model strut network, 23 nm (FIG. 9C). Though an approximation, this is further evidence that the mesoscopic architecture is determining the electron mean free path. For comparison, the mean free electron path in bulk indium metal at room temperature has been measured as 8.65 nm. If it is assumed that few impurities are introduced into the indium during the pressure infiltration, the mean free path should be at least an order of magnitude higher at temperatures <4 K. In the double gyroidal indium however, the implied mean free path is found to be 1.5 nm; within the confined strut network of the ceramic template the maximum possible line-of-sight path can range from a few nanometers in the surface normal direction to several hundreds of nanometers along certain crystallographic directions (FIG. 9C). In theory this may lead to other metamaterials behavior such as angle dependent magnetization or vortex pinning and magnetic lock-in/flux-trapping from particular alignment of the external field with respect to the orientation of a single crystal double gyroid metal network. Changing the mesoscale domain size of the template while maintaining the double gyroid morphology, or vice versa, could lead to other interesting phenomena. Through the use of bulk BCP self-assembly for the creation of networked mesoporous architectures, the platform described here uniquely combines all of these capabilities.

These proof-of-principle measurements of double gyroidal indium superconductors show substantial promise for high pressure metal infiltration of BCP derived ceramic templates as a facile, stable, and tunable platform for the investigation of complex 3D mesoscale geometries in metals. In this work, gyroid structured indium has been shown to be a quantum metamaterial: the induced mesoscopic architecture substantially changes superconducting properties through a modification of fundamental, quantum level characteristics, i.e. the superconducting coherence length. The backfilling of double gyroidal ceramic templates with other metals such as aluminum, silver, or gold is predicted to yield materials with novel photonic and electronic properties. Beyond pure metals, polymers, metallic glasses, and a few ordered crystalline materials have proven amenable to pressure driven nanomoulding. Finally, more extensive investigation into this emerging class of materials may be possible by expanding the high-pressure infiltration technique into single-crystal gyroidal templates, which have only recently become available. Thus, the use of high-pressure infiltration together with bulk BCP self-assembly—derived ceramic templates presents a wide array of potential projects bridging the disparate fields of soft matter and quantum materials.

Experimental Section. Materials. Unless otherwise stated, all chemicals were obtained from Sigma Aldrich and used as received. Polysilazane, trade name Durazane 1800, was donated by Greg McCraw of EMD Performance Material—Branchburg, New Jersey. Double gyroidal SiON ceramic templates were prepared using a previously-described method. In brief, 0.698 g of a poly(isoprene-b-styrene-b-dimethylamino ethylmethacrylate) “ISA” triblock terpolymer with overall molar mass 79 kDa (polydispersity of 1.09 with I, S, and A blocks having a volume fraction of 19.6%, 30.7%, and 49.7%, respectively) was mixed with 0.386 g of a commercial poly(methyl vinyl silazane) (PMVS) “Durazane 1800” and 20.425 g toluene. After mixing, the solution was allowed to evaporate in a double-diffusion cell at 40° C. over a span of two weeks to yield a free-standing, double gyroid structured hybrid monolith with a thickness of≈100 μm. This hybrid monolith was etched under CF4 plasma for 40 minutes on each side to remove any surface abnormalities. Small portions were then cut from the etched sample and heated to 1000° C. at a rate of 5° C. min⁻¹ under ammonia gas at a flow rate of 15 L min⁻¹ to produce freestanding double gyroidal monoliths. Indium wire (99.999% purity) was purchased from the Indium Corporation and cut into 1 cm sections. These sections were cleaned prior to use by rinsing in aqueous hydrochloric acid with a mass fraction of 10% followed by isopropanol. The sections were stored under isopropanol until use to inhibit oxide growth.

Small Angle X-Ray Scattering. SAXS data for the hybrid ISA/PMVS monolith (FIG. 2A, solid trace) was obtained at the Soft Matter Interfaces beamline (12-ID) of the National Synchrotron Light Source II (NSLS II). Data for the pyrolyzed porous double gyroidal ceramic template (FIG. 2A, dashed trace) was obtained at the G1 station at the Cornell High Energy Synchrotron Source (CHESS). Data for the composite indium backfilled ceramic (FIG. 2A, dotted trace) was acquired on a custom-built small angle x-ray scattering beamline. The home-built SAXS apparatus utilized a copper rotating anode x-ray generator and a phosphor-coupled charge-coupled detector. This setup is described in detail elsewhere. SAXS images taken at NSLS II were collected on a Pilatus 1M detector using a monochromatic x-ray beam with an energy of 16.10 keV and sample to detector distance of 8.3 m. SAXS images obtained at CHESS were collected with an energy of 9.84 keV and sample to detector distance of 2.2 m with an Eiger 1M pixel array detector. Two dimensional scattering images were integrated azimuthally using the Nika software package.

Nitrogen Physisorption. N₂ sorption measurements were performed on a Micromeritics ASAP 2020 Accelerated Surface Area and Porosimetry System. Powdered SiON ceramic was first degassed at 120° C. for 12 hours before sorption measurement at −196° C. Pore size distribution was calculated via the Barrett-Joyner-Halenda method.

High Pressure Infiltration. Sample infiltration was performed in a custom-built high pressure/high temperature cell, using a high pressure manifold described previously with some modifications. The cell consisted of a set of stainless steel fittings rated for 413 MPa (High Pressure Equipment Co.—Erie, Pennsylvania) wrapped in a fiberglass-jacketed heat tape with a K type thermocouple embedded in the fitting thread using thermal grease. Samples to be infiltrated were placed in ca. 3 cm long, 4 mm diameter glass tubes with one end sealed in order to contain the molten In and avoid contamination of the stainless steel cell walls. An activated carbon filter was placed between the cell and the manifold system to prevent indium vapor contamination of other parts of the apparatus. The temperature just beyond this carbon filter was actively monitored to check for any potential annealing behavior in the manifold itself. The manifold was connected to a portable turbomolecular pump (Edwards Inc.—Burgess Hill, United Kingdom), and routinely reached the pump base pressure of 10⁻⁵ Pa during pump-out. In a typical infiltration procedure, a SiON template was placed in the bottom of a glass tube. One or two 1 cm pieces of cleaned indium wire were then quickly placed in the tube and the tube inserted into the reactor. The reactor was connected to the pressure manifold and placed under vacuum, typically within 2 min of removal of the indium wire from storage in isopropanol. The sample was allowed to degas at 60° C. until the pump reached its base pressure, typically 8 to 12 hours. The cell was then heated at 10° C. min -1 to 250° C. and held at this temperature under vacuum. It is important to heat the metal above its melting temperature with the SiON template under vacuum so that the molten metal completely encapsulates the porous monolith. This ensures that when isostatic pressure via He gas is applied to the system, the pressure differential from the exterior of the melt to the interior pore volume is maximized, which is the driving force for infiltration. After 2 hours the valve to the vacuum system was closed and the manifold backfilled with helium gas. The high-pressure pump was then switched on until the manifold pressure reached about 400 MPa of helium, though it should be noted that successful infiltration was seen to take place using pressures of only 200 MPa. This pressure was held for one hour, after which the heating was switched off and the cell allowed to cool to 60 ° C. After depressurization the infiltrated composite monolith could then be retrieved by breaking the glass tube and carefully heating the indium slug until molten with a fine tipped soldering iron.

Scanning Electron Microscopy. Infiltrated monoliths were freeze fractured using liquid nitrogen, and the fractured cross section used for EDX characterization. Other pieces of the infiltrated monoliths were polished with diamond lapping films and used for backscattered electron imaging. Scanning electron micrographs and EDX measurements were taken using a Zeiss Gemini 500 microscope. Backscattered electron images were taken at an accelerating voltage of 1 keV, and EDX measurements taken at an accelerating voltage of 12 keV. For elemental mapping and cross section line scan data, EDX measurements were taken across the entirety of the image shown in FIG. 3B with a pixel size of 100 by 100 nm. AZtec software from Oxford Instruments was used for the data analysis.

Vibrating Sample Magnetometry. VSM data were taken using the Quantum Design VSM add-on for the Physical Property Measurement System (PPMS), equipped with a cryostat capable of accessing temperatures from 1.8 K to 400 K, a 9 T superconducting magnet, and an EverCool II Helium Reliquefier. Polished mesoporous Indium/SiON composites were briefly etched in 10% HCl to remove any bulk indium clinging to the surface. The polished and etched monolith was mounted using Lakeshore cryogenic varnish on a quartz brace, which was then press-fit into a brass half-tube sample holder with the polished sample surface normal to the magnetic field. For bulk comparison measurements, a small piece of indium wire from the same source was cut with a razor, pressed with a digital micrometer screw gauge to 100 μm thickness, and mounted similarly with the foil perpendicular to the magnetic field. In both cases, the sample was cooled to 2.0 K under zero applied field, then a small field of 2 mT was applied to locate the sample by scanning the VSM transport through its range. For moment vs. temperature measurements, the field was then ramped quickly to 8 mT and the sample warmed to 5 K at a rate of 0.25 K min⁻¹. For moment vs field measurements, the sample was located using the above procedure, then warmed to 5 K and zero-field-cooled to 2 K to erase any magnetic history. The field was then ramped at 5 mT s⁻¹ to 0.75 T, then back to −0.75 T and then finally to 0 T For all measurements, magnetic moment is normalized to the mass of indium metal present.

Four-point probe transport measurements. Data was obtained using the Quantum Design PPMS as described above. Etched and freshly polished indium/SiON composites (different than those used for VSM measurements) were mounted onto silicon carrier chips using small amounts of Lakeshore cryogenic varnish. (100) silicon carrier chips with a 100 nm thermal oxide layer were patterned with four gold contact pads, and 503 silver paint obtained from Electron Microscopy Sciences was used to make four co-linear contacts with the In/SiON composite and leads to the gold contact pads. The carrier chip containing the sample was then mounted to the PPMS via wirebonding. In all measurements, a 100 μA bias current was applied between the outermost contacts for resistance measurement. For resistance vs temperature measurements, the sample was cooled to 2 K under zero field, and the external field was quickly ramped to the respective value. The sample temperature was then ramped to 6 K at a rate of 0.2 K min⁻¹. For resistance vs field measurements, the sample was cooled to the respective temperature under zero field. The field was then ramped to 2 T at a rate of 5 mT s⁻¹. For all measurements the average of 10 measurements is reported, and the relative error at each point was measured as 3 orders of magnitude or lower than the reported resistance value.

Approximation of Pressures Required for Metal Infiltration of Mesoporous Templates. Equation (2), the Young-Laplace equation, gives the capillary pressure, ΔP, induced by a liquid of surface tension γ with a contact angle of θ on a solid with pores of diameter d. This relation has been shown to be valid down to the nanoscale. The surface tension of liquid indium has previously been reported as 573 mN/m, and the contact angle of liquid indium on silicon oxynitride can be approximated as 125° from studies on materials with very similar composition and surface energies. The pore diameter of the SiON template used in this case was measured to be an average of 18 nm.

$$Δ P = \frac{4 γcos θ}{d} \qquad ( 2 )$$

From Equation (2), pressures upwards of 70 MPa are required to overcome capillary pressure for infiltration in the double gyroidal ceramic template shown in this work. Extrapolation of this relation for indium metal across common length scales of bulk block-copolymer self-assembly derived structures shows that the range of pressures is easily accessible using commercially available high-pressure systems: from 26 MPa for 50 nm diameter pores to 260 MPa for 5 nm pores.

Modelling of Ballistic Paths within a Double Gyroid Strut Network. The double gyroid structure can be approximated by a level set function of the form shown in Equation (3), where x, y, and z are spatial coordinates, a is the unit cell length or the d₁₀₀, and t is a constant which determines the volume fractions of the spaces divided by the level surface. The surfaces at 0<|t|1.413 define two interpenetrating volumes which correspond to the left and right handed networks of the gyroid structure, separated by a matrix phase of finite thickness for 0<|t|.

$$F ( x , y , z ) = sin ( \frac{2 π x}{a} ) cos ( \frac{2 π y}{a} ) + sin ( \frac{2 π y}{a} ) cos ( \frac{2 π z}{a} ) + sin ( \frac{2 π z}{a} ) cos ( \frac{2 π x}{a} ) = \pm t \qquad ( 3 )$$

For the core-shell double gyroid structured ISA/PMVS composite films used in this work, the volume fraction of the hydrophilic matrix phase (A-block and PMVS) can be calculated as 71.2% by volume assuming a density of 1.18 g cm⁻³ for the PDMAEMA block of the ISA terpolymer and 1.00 g cm3 for the PMVS. If the composite structure is assumed to isotopically shrink during thermal processing without a significant change in the volume fraction occupied by the A+PMVS phase to that occupied by the SiON ceramic, the void fraction in the porous ceramic would be equal to that of the combined isoprene (core) and styrene (shell) in the parent film, 28.8% by volume. If the two void networks are assumed to be completely filled by indium metal upon infiltration, the volume occupied by the indium strut networks can be approximated by the level set function in Equation (2) with t=1.09. Through Monte Carlo sampling of ‘starting’ coordinates as well as ballistic path directions within this volume, the average ballistic path length can then be modeled.

In order to perform this modelling, the level set function is first evaluated with unit cell length a equal to the d₁₀₀ of the ceramic and indium/SiON composite as determined by SAXS, 73 nm (FIG. 2A). This evaluation is done on a three-dimensional mesh of points equally spaced at 3.65 nm and spanning three unit cells in the x, y, and z dimensions, with linear interpolation performed between these ‘vertex’ points to define ‘face’ which altogether comprise the level surface (FIG. 9A, shaded structure). After defining this surface, 4,446 points are randomly selected within the ‘interior’ of the networks such that t=F(x, y, z)<±=1.09. For every point selected in this way, a random direction is defined. The distance from the point to the closest intersection of the level surface is then measured within 0.25 nm, traveling in a straight line along the ‘forward’ direction randomly chosen as well as ‘backwards’ in the inverse direction. The total path length is then recorded as the sum of both the ‘forward’ and ‘backward’ path length (FIGS. 9A-9B, multiple lines). The relative frequency of path lengths is displayed in the histogram in FIG. 9C, with a bin size of 4 nm. The mean path length of all those samples was found to be 23 nm.

Experimental. X-ray Diffraction (XRD): XRD data was collected on a Bruker DS General Area Detector Diffraction System with a 1.6 kW Cu-Kα source and beam size of 0.5 mm. 2D diffraction images were collected at 15° intervals with a 5 minute exposure time at each angle. 2D images were stitched together and integrated into one-dimensional traces using Bruker Diffract Suite Software.

Vibrating Sample Magnetometry: Data was obtained using the VSM add-on for the Quantum Design PPMS DynaCool System. Double gyroidal SiON/In samples other than those measured in FIGS. 3A-3E were similarly etched, polished, and mounted with varnish onto quartz braces. After cooling to 2 K under zero field, samples were located by scanning the VSM through its range in an external field of 2 mT. Samples were then warmed to 10 K and cooled again to 2 K under zero field. Sample temperature was then set at the temperature as shown in FIG. 5, and the external field was scanned across all four quadrants from 0 T, to 1 T, to 0 T, to −1 T, then back to 0 T. Field strength was swept at a rate of 5 T s⁻¹, and the magnetic moment value was taken to be the average of 10 measurements at intervals of 25 mT. Magnetic moment measurements in all cases are normalized to the mass of indium metal present.

Although the present disclosure has been described with respect to one or more particular examples, it will be understood that other examples of the present disclosure may be made without departing from the scope of the present disclosure.

1. A method of making a templated material comprising:
contacting one or more inorganic material(s) and/or one or more organic material(s), or a combination thereof with a mesoporous block copolymer (BCP)-derived template defining a three-dimensional space,
applying a pressure to the inorganic material(s) and/or the organic material(s), or the combination thereof,
wherein the inorganic material(s) and/or the organic material(s), or the combination thereof at least partially, substantially, or completely fills the three-dimensional space forming a templated material.

2. The method of claim 1, wherein the inorganic material(s) are chosen from ceramic materials, amorphous glasses, semiconductor materials, metal(s), metal alloy(s), non-metal inorganic materials, and any combination thereof and/or the organic material(s) are chosen from polymers, oligomers, and organic molecules having a molar mass of 500 g/mol or less, and any combination thereof.

3. The method of claim 1, wherein the inorganic material(s) and/or the organic material(s), or the combination thereof is a liquid or the inorganic material(s) and/or the organic material(s), and/or the combination thereof is a solid at a temperature about or at or above one half of the melting point or glass transition of the inorganic material(s) and/or the organic material(s).

4. The method of claim 1, wherein the inorganic material(s) and/or the organic material(s), or the combination thereof is in the form of a melt.

5. The method of claim 1, wherein the BCP template is monolithic, a free-standing film, or a film disposed on at least a portion of or all of a surface or all of the surfaces of a substrate.

6. The method of claim 1, wherein the BCP-derived template comprises a ceramic material or a carbonaceous material.

7. The method of claim 1, wherein the BCP-derived template is a quantum confined material or exhibits one or more superconducting behavior(s).

8. The method of claim 1, wherein the BCP-derived templated material and/or templated material exhibits atomic level order and/or mesoscale level order or the BCP-derived templated material and/or templated material exhibits atomic level disorder and/or mesoscale level disorder.

9. The method of claim 1, wherein the templated material has the same mesoscale order as the BCP-derived template material.

10. The method of claim 1, wherein the BCP-derived template comprises one or more interpenetrating network(s) and at least a portion of or all of the void space network(s) are filled with templated material(s).

11. The method of claim 1, wherein the BCP-derived is continuous or co-continuous.

12. The method of claim 1, wherein the pressure is provided by an inert gas, an inert fluid, or an inert liquid or is a mechanical pressure.

13. The method of claim 1, wherein the pressure is greater than about 1 atm to 10⁴ atm.

14. The method of claim 1, wherein the contacting and applying are carried out at the same time, substantially the same time, or at different times.

15. The method of claim 1, the method further comprising removing at least a portion of, substantially all, or all of the BCP-derived template.

16. The method of claim 1, the method further comprising annealing the BCP-derived template and templated material or the templated material before or after removal of at least a portion of, substantially all, or all of the BCP-derived template.

17. A nanocomposite material comprising one or more inorganic material(s), one or more organic material(s), or any combination thereof defining a three-dimensional space and a BCP-derived material, wherein the BCP-derived material is disposed on at least at a portion of or substantially all of a surface or surfaces of the inorganic material(s), the organic material(s), or the combination thereof

18. The nanocomposite of claim 17, wherein the nanocomposite is monolithic, a free-stranding film, or a film disposed on at least a portion of or all of a surface or all of the surfaces of a substrate.

19. The nanocomposite of claim 17, wherein the inorganic material(s), the organic material(s), or the combination thereof or at least a portion thereof is continuous or co-continuous and comprises at least one surface access point.

20. The nanocomposite of claim 17, wherein the inorganic material(s), the organic material(s), or the combination thereof are symmetric or ordered inorganic material(s), symmetric or ordered organic material(s), or any combination thereof or asymmetric or disordered inorganic material(s), asymmetric or disordered organic material(s), or any combination thereof.

21. The nanocomposite of claim 17, wherein the inorganic material(s) are chosen from ceramic materials, amorphous glasses, semiconductor materials, metals, metal alloys, non-metal inorganic materials, and any combination thereof and/or the organic material(s) are chosen from polymers, oligomers, organic molecules having a molar mass of 500 g/mol or less, and any combination thereof

22. The nanocomposite of claim 21, wherein the metal(s) are chosen from In, Sn, Al, Pb, Hg, Bi, Ga, Cd, Hf, Ir, La, Li, Mo, Nb, Os, Pa, Re, Rh, Ru, Ta, Tc, Th, Ti, Tl, U, V, W, Zn, Zr, Au, Ag, Cu, Na, Ni, Fe, Co, and any combination thereof.

23. The nanocomposite of claim 21, wherein the semiconductor material(s) is/are chosen from crystalline inorganic semiconductor materials, amorphous inorganic semiconductor materials, organic polymer semiconductor materials, and any combination thereof.

24. The nanocomposite of claim 21, wherein the ceramic material(s), the metal(s), the metal alloy(s), or the combination thereof are superconducting at a temperature above about 1 K.

25. The nanocomposite of claim 24, wherein the ceramic material(s) is/are chosen from LaBaCuO, LaSrCuO, YBa₂Cu₃O₇ (YBCO), Bi₂Sr₂Ca₂Cu₃O₁₀ (BSCCO), T1BaCaCuO, HgBaCaCuO, and Hg₁₂Tl₃₀Ba₃₀Ca₃₀Cu₄₅O₁₂₇, and any combination thereof.

26. The nanocomposite of claim 24, wherein the metal(s) or metal alloy(s) is/are chosen from Al, Ga, In, Pb, Nb, Nb₃Sn, and NbTi, Nb₃Ge, and any combination thereof.

27. The nanocomposite of claim 17, wherein the BCP-derived material is monolithic, a free-standing film, or a film disposed on at least a portion of or all of a surface or all of the surfaces of a substrate.

28. The nanocomposite of claim 17, wherein the BCP-derived material comprises a ceramic material or a carbonaceous material.

29. The nanocomposite of claim 28, wherein the ceramic material is chosen from metal oxides, metal nitrides, metal carbides, metal oxynitrides, metal carbonitrides, and any combination thereof.

30. The nanocomposite of claim 28, wherein the carbonaceous material is chosen from graphitic carbon, amorphous carbon, nitrogen doped graphitic, amorphous carbon, and any combination thereof.

31. The nanocomposite of claim 17, wherein the BCP-derived template is a quantum confined material or exhibits one or more superconducting behavior(s).

32. The nanocomposite of claim 17, wherein the BCP-derived material and/or templated material exhibits atomic level order and/or mesoscale level order or the BCP-derived templated material and/or templated material exhibits atomic level disorder and/or mesoscale level disorder.

33. The nanocomposite of claim 17, wherein the one or more inorganic material(s), one or more organic material(s), or any combination thereof has/have the same mesoscale order as the BCP-derived template material.

34. The nanocomposite of claim 17, wherein the nanocomposite material comprises a plurality of interpenetrating networks, wherein the inorganic material(s), the organic material(s), or the combination thereof form one or more network(s) and BCP-derived template material(s) form one or more other network(s).

35. The nanocomposite of claim 34, wherein one or more (or all) of the individual network(s) provide(s) a continuous pathway throughout the three-dimensional volume of the nanocomposite material.

36. The nanocomposite of claim 17, wherein the inorganic material(s), the organic material(s), or the combination thereof defines a three-dimensional space corresponding to at least a part of or all of a cubic double gyroid matrix, a single gyroid matrix, a hexagonally packed cylinder matrix space, a hexagonally perforated lamellae space, an orthorhombic (O70) matrix, a double diamond matrix, an L₃ phase, or a Plumber's Nightmare matrix.

37. The nanocomposite of claim 17, wherein the BCP-derived material has the following structure: the majority volume of a double gyroid structure, the minority volumes of a double gyroid network structure, the minority volume of a single gyroid network structure, the majority volume of a hexagonal cylinder structure, the majority volume of the hexagonally perforated lamellar structure, the majority volume of the orthorhombic (O70) network structure, the minority volume of the orthorhombic (O70) network structure, the majority volume of the double diamond network structure, or the minority volumes of the double diamond network structure, and/or the one or more organic material(s) or the combination thereof occupy 60% or more of the void spaces of the BCP-derived material having the following structure: the minority volumes (there are two) of the double gyroid structure, the majority volume of the double gyroid network structure, the majority volume of the alternating (or single) gyroid network structure, the minority volume (i.e., the cylinder volume) of a hexagonal cylinder structure, the minority volume of the hexagonally perforated lamellar structure, the minority volume of the orthorhombic (O70) network structure, the majority volume of the orthorhombic (O70) network structure, the minority volumes of the double diamond network structure, the majority volume of the double diamond network structure, respectively.

38. The nanocomposite of claim 17, wherein at least a portion of or all of the inorganic material(s), the organic material(s) or the combination thereof are crystalline and/or amorphous.

39. The nanocomposite of claim 17, wherein the BCP-derived material comprises insulating material(s) and/or semiconducting material(s) and/or conducting material(s) and/or superconducting material(s) and/or one or more or all of the templated materials(s) comprises insulating material(s) and/or semiconducting material(s) and/or conducting material(s) and/or superconducting material(s).

40. The nanocomposite of claim 17, wherein the nanocomposite is a quantum confined material or exhibits one or more superconducting behavior(s).

41. A composition comprising one or more three-dimensional inorganic materials(s), one or more organic material(s), or any combination thereof.

42. The composition of claim 41, wherein the composition is monolithic, a free-standing film, or a film disposed on at least a portion of or all of a surface or all of the surfaces of a substrate.

43. The composition of claim 41, wherein at least a portion of or all of the inorganic material(s), the organic material(s), or the combination thereof is continuous or co-continuous.

44. The composition of claim 41, wherein the inorganic material(s), the organic material(s), or the combination thereof are symmetric or ordered inorganic material(s), symmetric or ordered material(s), or any combination thereof or asymmetric or disordered inorganic material(s), asymmetric or disordered organic material(s), or any combination thereof.

45. The composition of claim 41, wherein the inorganic material(s) are chosen from ceramic materials, amorphous glasses, semiconductor materials, metal(s), metal alloy(s), non-metal inorganic materials, and any combination thereof and/or the organic material(s) are chosen from polymers, oligomers, organic molecules having a molar mass of 500 g/mol or less, and any combination thereof.

46. The composition of claim 45, wherein the metal(s) are chosen from In, Sn, Al, Pb, Hg, Bi, Ga, Cd, Hf, Ir, La, Li, Mo, Nb, Os, Pa, Re, Rh, Ru, Ta, Tc, Th, Ti, Tl, U, V, W, Zn, Zr, Au, Ag, Cu, Na, Ni, Fe, Co, and any combination thereof

47. The composition of claim 45, wherein the semiconductor materials are chosen from crystalline inorganic semiconductor materials, amorphous inorganic semiconductor materials, organic polymer semiconductor materials, and any combination thereof.

48. The composition of claim 45, wherein the ceramic material(s), the metal(s), the metal alloy(s), or the combination thereof are superconducting at a temperature above about 1 K.

49. The composition of claim 48, wherein the ceramic material(s) are chosen from LaBaCuO, LaSrCuO, YBa₂Cu₃O₇ (YBCO), Bi₂Sr₂Ca₂Cu₃O₁₀ (BSCCO), T1BaCaCuO, HgBaCaCuO, and Hg₁₂Tl₃Ba₃₀Ca₃₀Cu₄₅O₁₂₇, and any combination thereof.

50. The composition of claim 48, wherein the metal(s) or metal alloy(s) are chosen from Al, Ga, In, Pb, Nb, Nb₃Sn, and NbTi, Nb₃Ge, and any combination thereof.

51. The composition of claim 41, wherein at least a portion of or all of the inorganic material(s), the organic material(s) or the combination thereof are crystalline and/or amorphous.

52. The composition of claim 41, wherein the composition exhibits atomic level order and/or mesoscale level order or the composition exhibits atomic level disorder and/or mesoscale level disorder.

53. The composition of claim 41, wherein the nanocomposite material comprises a plurality of interpenetrating networks.

54. The composition of claim 41, wherein the composition defines a three-dimensional space corresponding to at least a part of or all of a cubic double gyroid matrix, a single gyroid matrix, a hexagonally packed cylinder matrix space, a hexagonally perforated lamellae space, an orthorhombic (O70) matrix, or a double diamond matrix, or an L₃ phase.

55. The composition of claim 41, wherein the composition defines a space corresponding to 60% or more of the void spaces of: one or more majority volume(s) of a double gyroid structure, one or more minority volume(s) of a double gyroid network structure, a single gyroid network structure, a hexagonal cylinder structure, a hexagonally perforated lamellar structure, a minority volume of an orthorhombic network structure, a majority volume of an orthorhombic network structure), a minority volume of a double diamond network structure, or a majority volume of a double diamond network structure.

56. The composition of claim 41, wherein the composition comprises insulating material(s) and/or semiconducting material(s) and/or conducting material(s) and/or superconducting material(s).

57. The composition of claim 41, wherein the composition is a quantum confined material or exhibits one or more superconducting behavior(s).

58. A device comprising one or more nanocomposit(es) of claim 17.

59. The device of claim 58, wherein the device is an electronic device, energy device, or a sensor.

60. A device comprising one or more composition(s) of claim 41.

61. The device of claim 60, wherein the device is an electronic device, energy device, or a sensor.
